(19) United States
(12) Patent Application Publication
(10) Pub. No.: US 2024/0163711 A1
(43) Pub. Date: May 16, 2024

(54) DEPENDENCY IN PACKET DATA UNIT SET METADATA

(71) Applicant: QUALCOMM Incorporated, San Diego, CA (US)

(72) Inventors: Mickael Mondet, Louannec (FR); Prashanth Haridas Hande, San Diego, CA (US); Peerapol Tinnakornsrisuphap, San Diego, CA (US); Hyun Yong Lee, San Diego, CA (US); Diana Maamari, San Diego, CA (US); Linhai He, San Diego, CA (US); Ozcan Ozturk, San Diego, CA (US); Dario Serafino Tonesi, San Diego, CA (US); Thomas Stockhammer, Bergen (DE); Imed Bouazizi, Frisco, TX (US)

(21) Appl. No.: 18/054,537

(22) Filed: Nov. 10, 2022

(51) Int. Cl. H04W 28/02; H04L 1/00

(52) U.S. Cl. CPC H04W 28/0263; H04L 1/001

(57) ABSTRACT

Methods, systems, and devices for wireless communications are described. A wireless device may obtain an indication of a packet data unit (PDU) set dependency pattern for at least a first PDU set and a second PDU set of a group of PDU sets, where each PDU set of the group of PDU sets is associated with a same traffic flow. The PDU set dependency pattern may indicate a relationship between the first PDU set and the second PDU set for decoding the first PDU set and the second PDU set. The wireless device may obtain the indication of the PDU set dependency pattern as part of metadata associated with the first PDU set or via a control plane message. The wireless device may obtain the group of PDU sets and may decode at least the first PDU set and the second PDU set according to the PDU set dependency pattern.

### FIELD OF TECHNOLOGY

The following relates to wireless communications, including dependency in packet data unit (PDU) set metadata.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dependency in packet data unit (PDU) set metadata. For example, the described techniques provide for signaling of a PDU set dependency pattern that indicates relationships between one or more PDU sets of a group of PDU sets, which may be associated with a same traffic flow. Some PDU sets may depend on information included in one or more other PDU sets for successful processing (e.g., encoding, decoding). Accordingly, the PDU set dependency pattern may, for example, indicate that a given PDU set of the group of PDU sets is dependent on one or more other PDU sets of the group of PDU sets. Additionally, or alternatively, the PDU set dependency pattern may indicate one or more PDU sets that depend on a given PDU set.

In some cases, the group of PDU sets may include PDU sets associated with different quality of service (QoS) flows. A transmitting device or function may output the group of PDU sets and an indication of the PDU set dependency pattern, e.g., via a user plane as part of metadata associated with the PDU sets or via a control plane as separate signaling. A receiving device obtaining the group of PDU sets and the PDU set dependency pattern may decode the PDU sets in accordance with the PDU set pattern.

A method for wireless communications at a wireless device is described. The method may include obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow, obtaining the second PDU set, where the first PDU set is associated with a first QoS flow and the second PDU set is associated with a second QoS flow, and decoding at least the first PDU set and the second PDU set based on the PDU set dependency pattern.

An apparatus for wireless communications at a wireless device is described. The apparatus may include a processor, memory coupled with the processor, and instructions stored in the memory. The instructions may be executable by the processor to cause the apparatus to obtain an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow, obtain the second PDU set, where the first PDU set is associated with a first QoS flow and the second PDU set is associated with a second QoS flow, and decode at least the first PDU set and the second PDU set based on the PDU set dependency pattern.

Another apparatus for wireless communications at a wireless device is described. The apparatus may include means for obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow, means for obtaining the second PDU set, where the first PDU set is associated with a first QoS flow and the second PDU set is associated with a second QoS flow, and means for decoding at least the first PDU set and the second PDU set based on the PDU set dependency pattern.

A non-transitory computer-readable medium storing code for wireless communications at a wireless device is described. The code may include instructions executable by a processor to obtain an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow, obtain the second PDU set, where the first PDU set is associated with a first QoS flow and the second PDU set is associated with a second QoS flow, and decode at least the first PDU set and the second PDU set based on the PDU set dependency pattern.

In some examples of the method, apparatuses, and non-transitory computer-readable medium described herein, obtaining the indication of the PDU set dependency pattern may include operations, features, means, or instructions for obtaining, via a control plane, a message including the PDU set dependency pattern.

Some examples of the method, apparatuses, and non-transitory computer-readable medium described herein may further include operations, features, means, or instructions for obtaining, as part of metadata associated with the first PDU set, an indication of a start of the PDU dependency pattern.

In some examples of the method, apparatuses, and non-transitory computer-readable medium described herein, the indication of the PDU set dependency pattern includes a bitmap associated with the first PDU set having a length equal to a quantity of PDU sets in the group of PDU sets, the bitmap indicating the relationship between the first PDU set and one or more PDU sets of the group of PDU sets.

In some examples of the method, apparatuses, and non-transitory computer-readable medium described herein, each bit of the bitmap corresponds to a respective PDU set of the group of PDU sets and a value of each bit indicates whether the respective PDU set may be dependent on the first PDU set.

In some examples of the method, apparatuses, and non-transitory computer-readable medium described herein, obtaining the indication of the PDU set dependency pattern may include operations, features, means, or instructions for obtaining the first PDU set and metadata associated with the first PDU set, the metadata indicating the PDU set dependency pattern.

In some examples of the method, apparatuses, and non-transitory computer-readable medium described herein, the PDU set dependency pattern indicates a relationship between each PDU set in the subset of PDU sets.

In some examples of the method, apparatuses, and non-transitory computer-readable medium described herein, the metadata associated with the first PDU set further indicates that the PDU set dependency pattern may be to be restarted.

In some examples of the method, apparatuses, and non-transitory computer-readable medium described herein, obtaining the indication of the PDU set dependency pattern may include operations, features, means, or instructions for obtaining the first PDU set and first metadata associated with the first PDU set and obtaining second metadata associated with the second PDU set, the first metadata and the second metadata indicating the PDU set dependency pattern.

In some examples of the method, apparatuses, and non-transitory computer-readable medium described herein, a value of a first bit in the first metadata indicates whether the first PDU set may be dependent on the second PDU set for the decoding based on a frame type associated with the first PDU set and the second PDU set.

In some examples of the method, apparatuses, and non-transitory computer-readable medium described herein, a value of a second bit in the second metadata indicates whether the second PDU set may be dependent on the first PDU set for the decoding based on a frame type associated with the first PDU set and the second PDU set.

In some examples of the method, apparatuses, and non-transitory computer-readable medium described herein, the first metadata further indicates a QoS flow identifier (QFI) for the first QoS flow and the second metadata further indicates a QFI for the second QoS flow, the first QoS flow being different from the second QoS flow.

In some examples of the method, apparatuses, and non-transitory computer-readable medium described herein, the first metadata further indicates a frame type associated with the first PDU set and the second metadata further indicates a frame type associated with the second PDU set.

In some examples of the method, apparatuses, and non-transitory computer-readable medium described herein, the second metadata indicates one or more PDU set sequency numbers associated with one or more PDU sets of the group of PDU sets and the second PDU set may be dependent on the one or more PDU sets of the group of PDU sets for the decoding.

In some examples of the method, apparatuses, and non-transitory computer-readable medium described herein, the second metadata further indicates one or more QFIs associated with the one or more PDU sets of the group of PDU sets based on the first QoS flow being different from the second QoS flow.

In some examples of the method, apparatuses, and non-transitory computer-readable medium described herein, the first metadata indicates one or more PDU set sequency numbers associated with one or more PDU sets of the group of PDU sets and the one or more PDU sets of the group of PDU sets may be dependent on the first PDU set for the decoding.

In some examples of the method, apparatuses, and non-transitory computer-readable medium described herein, the first metadata further indicates one or more QFIs associated with the one or more PDU sets of the group of PDU sets based on the first QoS flow being different from the second QoS flow.

In some examples of the method, apparatuses, and non-transitory computer-readable medium described herein, obtaining the indication of the PDU set dependency pattern may include operations, features, means, or instructions for obtaining the first PDU set and metadata associated with the first PDU set, the metadata indicating the PDU set dependency pattern, where the second PDU set may be dependent on the first PDU set based on the PDU set dependency pattern.

Some examples of the method, apparatuses, and non-transitory computer-readable medium described herein may further include operations, features, means, or instructions for obtaining, as part of the metadata, an indication of a PDU sequence number associated with the second PDU set.

In some examples of the method, apparatuses, and non-transitory computer-readable medium described herein, the indication of the PDU sequence number includes an absolute value, a relative value with respect to a PDU sequence number associated with the first PDU set, or a bitmap.

In some examples of the method, apparatuses, and non-transitory computer-readable medium described herein, the first QoS flow may be different from the second QoS flow and the method, apparatuses, and non-transitory computer-readable medium may include further operations, features, means, or instructions for obtaining, as part of the metadata, an indication of a QFI for the second QoS flow.

In some examples of the method, apparatuses, and non-transitory computer-readable medium described herein, the indication of the QFI includes an absolute value, a relative value with respect to a QFI associated with the first PDU set, or a bitmap.

In some examples of the method, apparatuses, and non-transitory computer-readable medium described herein, the indication of the QFI for the second QoS flow corresponds to a PDU sequence number associated with the second PDU set.

Some examples of the method, apparatuses, and non-transitory computer-readable medium described herein may further include operations, features, means, or instructions for obtaining, as part of the metadata, an indication of a highest dependency depth for the first PDU set, the highest dependency depth corresponding to a recurrent dependency level associated with a subset of PDU sets of the group of PDU sets that depend on the first PDU set for the decoding.

Some examples of the method, apparatuses, and non-transitory computer-readable medium described herein may further include operations, features, means, or instructions for obtaining, as part of the metadata, an indication of an actual dependency depth for the first PDU set, the actual dependency depth associated with a quantity of PDU sets that depend on the first PDU set.

Some examples of the method, apparatuses, and non-transitory computer-readable medium described herein may further include operations, features, means, or instructions for obtaining a message indicating a threshold actual dependency depth for the group of PDU sets.

In some examples of the method, apparatuses, and non-transitory computer-readable medium described herein, obtaining the indication of the PDU set dependency pattern may include operations, features, means, or instructions for obtaining the first PDU set and metadata associated with the first PDU set and obtaining second metadata associated with the second PDU set, the second metadata indicating the PDU set dependency pattern, where the second PDU set may be dependent on the first PDU set based on the PDU set dependency pattern.

Some examples of the method, apparatuses, and non-transitory computer-readable medium described herein may further include operations, features, means, or instructions for obtaining, as part of the metadata, an indication of a highest dependency depth for the second PDU set, the highest dependency depth corresponding to a recurrent dependency level associated with a subset of PDU sets of the group of PDU sets on which the second PDU set depends for the decoding.

Some examples of the method, apparatuses, and non-transitory computer-readable medium described herein may further include operations, features, means, or instructions for obtaining, as part of the metadata, an indication of an actual dependency depth for the second PDU set, the actual dependency depth associated with a quantity of PDU sets on which the second PDU set depends.

In some examples of the method, apparatuses, and non-transitory computer-readable medium described herein, obtaining the indication of the PDU set dependency pattern may include operations, features, means, or instructions for obtaining, by a modem of the wireless device, the indication of the PDU set dependency pattern from an application function of the wireless device.

In some examples of the method, apparatuses, and non-transitory computer-readable medium described herein, obtaining the indication of the PDU set dependency pattern may include operations, features, means, or instructions for obtaining, from a UE, the indication of the PDU set dependency pattern via a radio resource control message or a media access control (MAC) control element (MAC-CE).

A method for wireless communications at a wireless device is described. The method may include encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets is associated with a same service flow, outputting an indication of the PDU set dependency pattern based on the encoding, and outputting the second PDU set, where the first PDU set is associated with a first QoS flow and the second PDU set is associated with a second QoS flow.

An apparatus for wireless communications at a wireless device is described. The apparatus may include a processor, memory coupled with the processor, and instructions stored in the memory. The instructions may be executable by the processor to cause the apparatus to encode at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets is associated with a same service flow, output an indication of the PDU set dependency pattern based on the encoding, and output the second PDU set, where the first PDU set is associated with a first QoS flow and the second PDU set is associated with a second QoS flow.

Another apparatus for wireless communications at a wireless device is described. The apparatus may include means for encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets is associated with a same service flow, means for outputting an indication of the PDU set dependency pattern based on the encoding, and means for outputting the second PDU set, where the first PDU set is associated with a first QoS flow and the second PDU set is associated with a second QoS flow.

A non-transitory computer-readable medium storing code for wireless communications at a wireless device is described. The code may include instructions executable by a processor to encode at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets is associated with a same service flow, output an indication of the PDU set dependency pattern based on the encoding, and output the second PDU set, where the first PDU set is associated with a first QoS flow and the second PDU set is associated with a second QoS flow.

In some examples of the method, apparatuses, and non-transitory computer-readable medium described herein, outputting the indication of the PDU set dependency pattern may include operations, features, means, or instructions for outputting, via a control plane, a message including the PDU set dependency pattern.

In some examples of the method, apparatuses, and non-transitory computer-readable medium described herein, outputting, as part of metadata associated with the first PDU set, an indication of a start of the PDU dependency pattern.

In some examples of the method, apparatuses, and non-transitory computer-readable medium described herein, outputting the indication of the PDU set dependency pattern may include operations, features, means, or instructions for outputting the first PDU set and metadata associated with the first PDU set, the metadata indicating the PDU set dependency pattern.

In some examples of the method, apparatuses, and non-transitory computer-readable medium described herein, outputting the indication of the PDU set dependency pattern may include operations, features, means, or instructions for outputting the first PDU set and first metadata associated with the first PDU set and outputting second metadata associated with the second PDU set, the first metadata and the second metadata indicating the PDU set dependency pattern.

In some examples of the method, apparatuses, and non-transitory computer-readable medium described herein, a value of a first bit in the first metadata indicates whether the first PDU set may be dependent on the second PDU set for the encoding based on a frame type associated with the first PDU set and the second PDU set.

In some examples of the method, apparatuses, and non-transitory computer-readable medium described herein, a value of a second bit in the second metadata indicates whether the second PDU set may be dependent on the first PDU set for the encoding based on a frame type associated with the first PDU set and the second PDU set.

In some examples of the method, apparatuses, and non-transitory computer-readable medium described herein, the first metadata further indicates a QFI for the first QoS flow and the second metadata further indicates a QFI for the second QoS flow, the first QoS flow being different from the second QoS flow.

In some examples of the method, apparatuses, and non-transitory computer-readable medium described herein, the first metadata further indicates a frame type associated with the first PDU set and the second metadata further indicates a frame type associated with the second PDU set.

In some examples of the method, apparatuses, and non-transitory computer-readable medium described herein, the second PDU set may be dependent on the one or more PDU sets of the group of PDU sets for the encoding.

In some examples of the method, apparatuses, and non-transitory computer-readable medium described herein, the second metadata further indicates one or more QFIs associated with the one or more PDU sets of the group of PDU sets based on the first QoS flow being different from the second QoS flow.

In some examples of the method, apparatuses, and non-transitory computer-readable medium described herein, the first metadata indicates one or more PDU set sequency numbers associated with one or more PDU sets of the group of PDU sets and the one or more PDU sets of the group of PDU sets may be dependent on the first PDU set for the encoding.

In some examples of the method, apparatuses, and non-transitory computer-readable medium described herein, the first metadata further indicates one or more QFIs associated with the one or more PDU sets of the group of PDU sets based on the first QoS flow being different from the second QoS flow.

In some examples of the method, apparatuses, and non-transitory computer-readable medium described herein, outputting the indication of the PDU set dependency pattern may include operations, features, means, or instructions for outputting the first PDU set and metadata associated with the first PDU set, the metadata indicating the PDU set dependency pattern, where the second PDU set may be dependent on the first PDU set based on the PDU set dependency pattern.

In some examples of the method, apparatuses, and non-transitory computer-readable medium described herein, outputting, as part of the metadata, an indication of a PDU sequence number associated with the second PDU set.

In some examples of the method, apparatuses, and non-transitory computer-readable medium described herein, the indication of the PDU sequence number includes an absolute value, a relative value with respect to a PDU sequence number associated with the first PDU set, or a bitmap.

In some examples of the method, apparatuses, and non-transitory computer-readable medium described herein, the first QoS flow may be different from the second QoS flow and the method, apparatuses, and non-transitory computer-readable medium may include further operations, features, means, or instructions for outputting, as part of the metadata, an indication of a QFI for the second QoS flow.

In some examples of the method, apparatuses, and non-transitory computer-readable medium described herein, the indication of the QFI includes an absolute value, a relative value with respect to a QFI associated with the first PDU set, or a bitmap.

In some examples of the method, apparatuses, and non-transitory computer-readable medium described herein, the indication of the QFI for the second QoS flow corresponds to a PDU sequence number associated with the second PDU set.

In some examples of the method, apparatuses, and non-transitory computer-readable medium described herein, outputting, as part of the metadata, an indication of a highest dependency depth for the first PDU set, the highest dependency depth corresponding to a recurrent dependency level associated with a subset of PDU sets of the group of PDU sets that depend on the first PDU set for the encoding.

In some examples of the method, apparatuses, and non-transitory computer-readable medium described herein, outputting, as part of the metadata, an indication of an actual dependency depth for the first PDU set, the actual dependency depth associated with a quantity of PDU sets that depend on the first PDU set.

Some examples of the method, apparatuses, and non-transitory computer-readable medium described herein may further include operations, features, means, or instructions for obtaining a message indicating a threshold actual dependency depth for the group of PDU sets.

In some examples of the method, apparatuses, and non-transitory computer-readable medium described herein, outputting the indication of the PDU set dependency pattern may include operations, features, means, or instructions for outputting the first PDU set and metadata associated with the first PDU set and outputting second metadata associated with the second PDU set, the second metadata indicating the PDU set dependency pattern, where the second PDU set may be dependent on the first PDU set based on the PDU set dependency pattern.

In some examples of the method, apparatuses, and non-transitory computer-readable medium described herein, outputting, as part of the metadata, an indication of a highest dependency depth for the second PDU set, the highest dependency depth corresponding to a recurrent dependency level associated with a subset of PDU sets of the group of PDU sets on which the second PDU set depends for the encoding.

In some examples of the method, apparatuses, and non-transitory computer-readable medium described herein, outputting, as part of the metadata, an indication of an actual dependency depth for the second PDU set, the actual dependency depth associated with a quantity of PDU sets on which the second PDU set depends.

In some examples of the method, apparatuses, and non-transitory computer-readable medium described herein, outputting the indication of the PDU set dependency pattern may include operations, features, means, or instructions for outputting the indication of the PDU set dependency pattern by an application function of the wireless device.

In some examples of the method, apparatuses, and non-transitory computer-readable medium described herein, outputting the indication of the PDU set dependency pattern may include operations, features, means, or instructions for outputting the indication of the PDU set dependency pattern via a radio resource control message or a MAC-CE.

### BRIEF DESCRIPTION OF THE DRAWINGS

FIG. 1 illustrates an example of a wireless communications system that supports dependency in packet data unit (PDU) set metadata in accordance with one or more aspects of the present disclosure.

FIG. 2 illustrates an example of a network architecture that supports dependency in PDU set metadata in accordance with one or more aspects of the present disclosure.

FIG. 3 illustrates an example of a wireless communications system that supports dependency in PDU set metadata in accordance with one or more aspects of the present disclosure.

FIG. 4 illustrates an example of a network diagram that supports dependency in PDU set metadata in accordance with one or more aspects of the present disclosure.

FIGS. 5A and 5B illustrate examples of PDU set dependency patterns that support dependency in PDU set metadata in accordance with one or more aspects of the present disclosure.

FIG. 6 illustrates an example of a process flow that supports dependency in PDU set metadata in accordance with one or more aspects of the present disclosure.

FIGS. 7 and 8 illustrate block diagrams of devices that support dependency in PDU set metadata in accordance with one or more aspects of the present disclosure.

FIG. 9 illustrates a block diagram of a communications manager that supports dependency in PDU set metadata in accordance with one or more aspects of the present disclosure.

FIG. 10 illustrates a diagram of a system including a user equipment (UE) that supports dependency in PDU set metadata in accordance with one or more aspects of the present disclosure.

FIG. 11 illustrates a diagram of a system including a network entity that supports dependency in PDU set metadata in accordance with one or more aspects of the present disclosure.

FIGS. 12 through 16 illustrate flowcharts showing methods that support dependency in PDU set metadata in accordance with one or more aspects of the present disclosure.

### DETAILED DESCRIPTION

In some wireless communications systems, one or more devices (e.g., network entities, user equipment (UE)) or functionalities, components, or modules of such devices may support applications or services enabling the one or more devices to process and prepare one or more data packets, such as packet data units (PDUs) based on a dependency pattern. For example, PDUs originating at an application function (AF) of a device may be communicated to other layers or functions of the same device, or may be communicated to a different device. In some cases, a device or functionality may process and prepare the one or more data packets on a packet-by-packet basis, e.g., may process and prepare each data packet individually. For example, an application server (AS) entity may send a single packet to a user plane function (UPF), which may send the single packet to a radio access network (RAN), which may transmit the single packet to a UE.

In other cases, such as video applications, extended reality (XR), virtual reality (VR), mixed reality (MR), or the like, a device or functionality may extend a data packet processing and preparation framework to handle a set or a burst of multiple packets together (such that the set of multiple packets are sent together, at a same time, at approximately the same time, or within a short period of time), which may be referred to as a PDU set. A PDU set may collectively indicate one or more units of information. Thus, the RAN may obtain more complete insight into the data traffic between the AS and the UE, which may enable the RAN to allocate resources for packet transmissions between the RAN and the UE more efficiently.

In some examples, processing and preparing a given PDU set may rely on information included in another PDU set. For instance, in a video application, a first PDU set may include or be an example of an intra-frame (I-frame), a second PDU set may include or be an example of a predicted frame (P-frame), and a third PDU set may include or be an example of a bidirectional frame (B-frame). The second PDU set (e.g., the P-frame) may be processed and prepared (e.g., encoded and compressed) based on information included in the first PDU set (e.g., the I-frame). The third PDU set (e.g., the B-frame) may be processed and prepared (e.g., encoded and compressed) based on information included in both the first PDU set and the second PDU set. Accordingly, a receiving device may not be able to decode the second PDU set without successfully receiving and decoding the first PDU set, nor the third PDU set without successfully receiving and decoding the first PDU set and the second PDU set. Further, different PDU sets may have different levels of importance for encoding or decoding procedures. For example, the first PDU set may be considered more important than the second or third PDU sets, which cannot be decoded without the first PDU set.

The techniques described herein support signaling of dependencies (e.g., one or more dependency patterns) between PDU sets, such that a device or functionality may appropriately handle multiple PDU sets. For example, a receiving device or functionality may obtain an indication of a PDU set pattern (e.g., a PDU set dependency pattern) for a group of PDU sets. The PDU set pattern may indicate whether each PDU set of the group of PDU sets is dependent on one or more other PDU sets (e.g., for encoding or decoding) of the group of PDU sets. Additionally, or alternatively, the PDU set pattern may indicate whether one or more other PDU sets of the group of PDU sets are dependent on each PDU set of the group of PDU sets. If the receiving device fails to successfully receive a PDU set, the receiving device may discard any other PDU sets that depend on the failed PDU set according to the PDU set pattern, which may improve processing efficiency and reduce latency. As another example, a transmitting device or functionality that outputs the group of PDU sets may prioritize or otherwise handle each PDU set based on the PDU set pattern. For instance, the transmitting device may schedule a PDU set on which one or more other PDU sets depend (e.g., according to the PDU set pattern) with a relatively more robust modulation and coding scheme (MCS) (e.g., an MCS having a higher likelihood of successful decoding at a receiving device) than a PDU set that does not have dependent PDU sets.

In some cases, the PDU set pattern may be signaled between devices, such as via control signaling between a network entity and a UE, or from an AS to a network entity and from the network entity to a UE. Additionally, or alternatively, the PDU set pattern may be indicated as part of metadata that is communicated along with one or more PDU sets of the group of PDU sets, for example, via a user plane. Other information may be included with or as part of a PDU set pattern, such as a quality of service (QoS) flow identifier (QFI) associated with each PDU set, a PDU set sequence number associated with each PDU set, or the like, among other examples.

Aspects of the disclosure are initially described in the context of wireless communications systems. Aspects of the disclosure are additionally illustrated by and described with reference to a network diagram, PDU set dependency patterns, and a process flow. Aspects of the disclosure are further illustrated by and described with reference to apparatus diagrams, system diagrams, and flowcharts that relate to dependency in packet data unit set metadata.

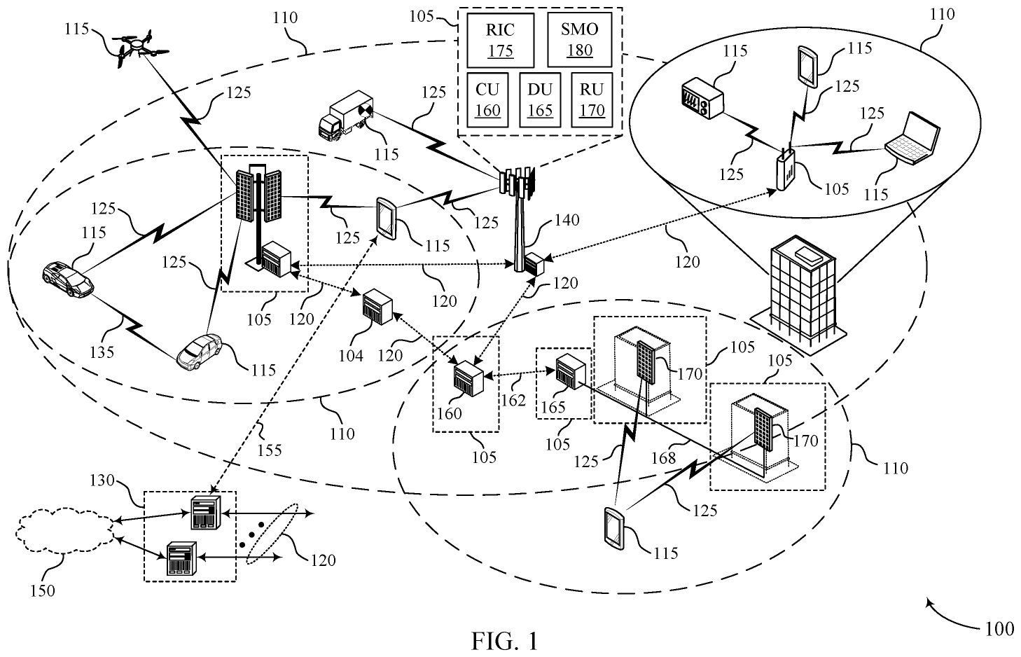

FIG. 1 illustrates an example of a wireless communications system 100 that supports dependency in PDU set metadata in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support dependency in PDU set metadata as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, devices or functions in the wireless communications system 100 may support handling multiple packets (e.g., data packets) together. The multiple packets (e.g., PDUs) may be grouped into PDU sets (also referred to as application data units (ADUs)), data bursts (e.g., PDU bursts), or both. For example, a set of packets jointly processed by an application may be referred to as a PDU set. A burst may refer to a group of PDU sets generated by an application at approximately a same time. PDU sets may be communicated between layers or functions within a device, or between devices of the wireless communications system 100. For example, a network entity 105 (equivalently referred to as a gNB) may transmit PDU sets to a UE 115. The network entity 105 may transmit PDU sets in bursts at approximately the same time. In some cases, PDU sets may originate at an AF or AS, which may be located outside of the core network 130. In such cases, the PDU sets may be routed from the AF/AS to a UE 115 via a UPF and one or more elements or components of the network entity 105.

Each PDU set may include metadata that includes information related to the PDU set (e.g., related to PDUs belonging to the PDU set). The PDU set metadata may be provided by the AS or implicitly determined by a UPF service layer. PDU set metadata may indicate a number (e.g., quantity) of PDUs in a PDU set, a PDU set sequence number that identifies the PDU set, a PDU sequence number that identifies a PDU within the PDU set, a PDU set burst number, a PDU set discard time, or the like, among other examples. In some cases, PDU set metadata may include fields that define rules for determining the delivery status of a PDU set. For example, the PDU set metadata may define the number, ratio, or percentage of PDUs in a PDU set to be received for successful PDU set delivery.

Processing a PDU set at a transmitting device or function may involve preparing, compressing, and encoding the PDU sets. Processing a PDU set at a receiving device or function may involve receiving and decoding the PDU sets. In some cases, information included in a PDU set may be associated with or otherwise depend on information included in one or more other PDU sets. Thus, a device may be unable to process the PDU set without the one or more other PDU sets. The PDU set may be referred to as being dependent on the one or more other PDU sets.

Aspects of the present disclosure support signaling of a PDU set dependency pattern that indicates relationships between PDU sets. For example, a transmitting device or function may output (e.g., communicate, provide, transmit) a group of PDU sets (e.g., generated by an application at the transmitting device or function) and a PDU set dependency pattern, where the PDU set dependency pattern indicates whether each PDU set depends on one or more other PDU sets (of the group of PDU sets). In some cases, the transmitting device may output the PDU set dependency pattern via the user plane, e.g., as part of PDU set metadata associated with one or multiple PDU sets of the group of PDU sets. In other cases, the transmitting device may output the PDU set dependency pattern via the control plane, e.g., via signaling separate from the PDU sets. A receiving device may obtain the group of PDU sets and the PDU set dependency pattern and may decode each PDU set according to the PDU set dependency pattern.

Further, as described herein, the term “output” may generally refer to any method or means for outputting information, including, for example, transmitting, signaling, messaging, conveying, indicating, and the like. Further, outputting may include outputting via wireless signaling, via wired signaling, or via a combination of wired and wireless signaling. Similarly, as described herein, the term “obtain” may generally refer to any method or means for obtaining information, including, for example, receiving, sensing, extracting, measuring, and the like. Further, obtaining may include obtaining via wireless signaling, via wired signaling, or via a combination of wired and wireless signaling.

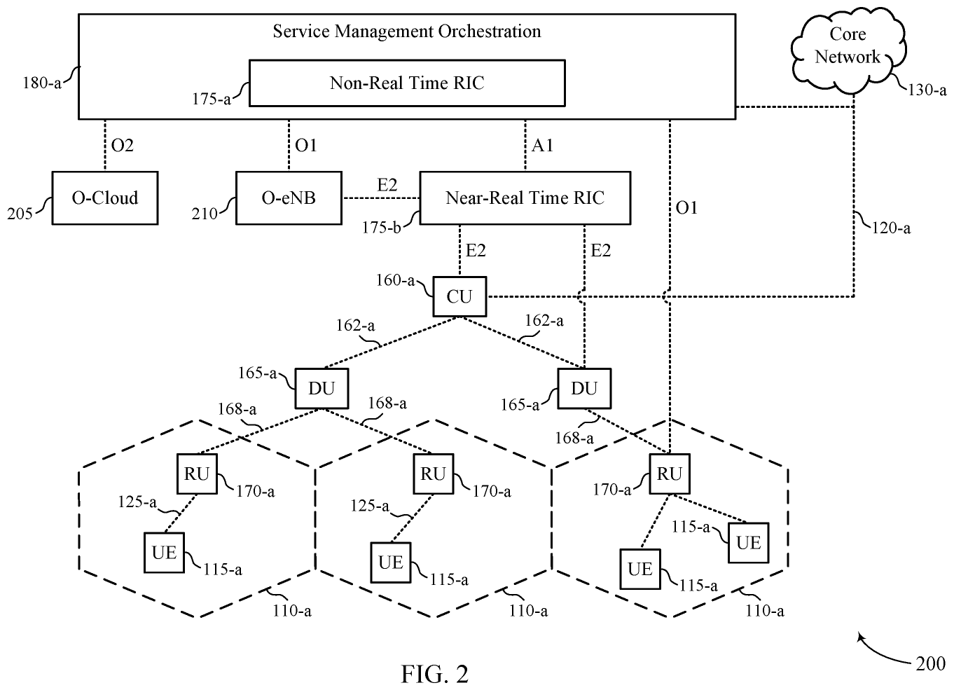

FIG. 2 illustrates an example of a network architecture 200 (e.g., a disaggregated base station architecture, a disaggregated RAN architecture) that supports dependency in PDU set metadata in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The methods and techniques described herein may be used for a wide range of PDU set configurations and deployment scenarios. For example, the described techniques may be implemented for communications between an AS or AF that is outside of the core network 130-a and one or more devices of the core network 130-a. The AS or AF may route the PDU set dependency pattern via a control plane of the core network 130-a to the CU 160-a. In some cases, the CU 160-a may transmit the PDU set dependency pattern to the UE 115-a via the DU 165-a. Additionally, or alternatively, the AS or AF may route the PDU set dependency pattern directly to the UE 115-a via a control plane of the core network 130-a.

Additionally, the described techniques may be implemented for communications between layers or functions within a device. For example, the PDU sets and PDU set dependency pattern may originate at an application of the UE 115-a. The application at the UE 115-a may provide the PDU set dependency pattern to a modem of the UE 115-a. In some examples, the UE 115-a may further communicate the PDU set dependency pattern to the DU 165-a via the CU 160-a. It is to be understood that the examples discussed herein are not limiting, and the described techniques may be applied or implemented by any type and quantity of device, functionality, or combination thereof.

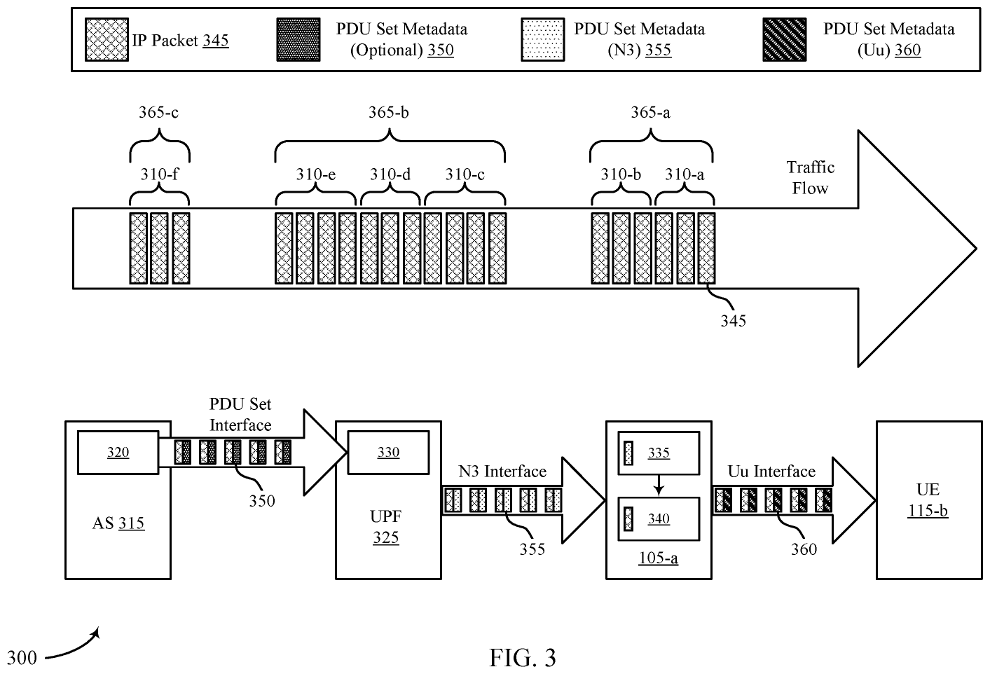

FIG. 3 illustrates an example of a wireless communications system 300 that supports dependency in PDU set metadata in accordance with one or more aspects of the present disclosure. The wireless communications system 300 may implement or be implemented by aspects of the wireless communications system 100 or the network architecture 200. For example, the wireless communications system 300 may include a UE 115-b and a network entity 105-a (also referred to as a gNB), which may be examples of corresponding devices described with reference to FIG. 1. The network entity 105-a may include a PDU set schedule control unit 335 and a scheduler 340. In the wireless communications system 300, one or more PDU sets may be transmitted from an AS 315 to the UE 115-b by means of a UPF 325 and the network entity 105-a.

Applications may process (consume) data in PDU sets (e.g., PDU sets 310). A PDU set is a set of packets (e.g., data packets, such as IP packets 345) jointly processed by an application (e.g., an application layer). A burst (e.g., a burst 365) is a group of PDU sets generated by an application at approximately the same time. A PDU set 310 may include one or more PDUs that carry a payload of one unit of information generated at an application level, such as a frame or video slice (e.g., for an XR service). In some examples, a PDU set 310 may be referred to or understood as an application data unit (ADU). PDU sets may be associated with a same traffic flow, which may also be referred to as a service flow. The wireless communications system 300 illustrates an exemplary traffic flow for downlink PDU sets and PDU set metadata associated with the PDU sets, where the AS 315 may communicate PDU sets to the UE 115-b via the UPF 325 and the network entity 105-a. However, the principles described herein are applicable to uplink as well. In the example of FIG. 3, a burst 365-a may include a PDU set 310-a and a PDU set 310-b, a burst 365-b may include a PDU set 310-c, a PDU set 310-d, and a PDU set 310-e, and a burst 365-c may include a PDU set 310-f. As an example, there may be one video frame (or a slice of a video frame) per burst 365.

As illustrated in FIG. 3, the PDU sets 310 may be generated at an application 320 of an AS 315 which, in some examples, may be outside of a core network (e.g., a 5G core network). The AS 315 may generate the PDU sets 310 (e.g., of each burst 365) for simultaneous (or approximately simultaneous) processing or handling to be exchanged with a RAN (e.g., the network entity 105-a). Each PDU set 310 may collectively indicate or convey at least one unit of information. A burst 365 may include more than one PDU set 310 and, accordingly, convey more than one unit of information. Within the traffic flow, different PDU sets 310 may be mapped to different QoS flows.

For each PDU set 310 delivered by the application 320 on the AS 315, information related to (e.g., information about) the PDU set 310 may be passed to the RAN and the UE 115-b. This information may be equivalently referred to herein as PDU set metadata or control information. PDU set metadata for a given PDU set may be included in a header of the PDU. A service layer 330 of the UPF 325 may obtain the PDU set 310 from the application 320 via a PDU set interface. The AS 315 may explicitly provide PDU set metadata 350 associated with the PDU set 310 to the service layer 330 of the UPF 325, or the service layer 330 may implicitly determine (e.g., learn) the PDU set metadata 350 (e.g., from the traffic flow). The service layer 330 may decouple PDU set signaling from the AS 315 to the UPF 325 and PDU set signaling within a 5G system (e.g., from the UPF 325 to the RAN), such that the PDU set signaling may be independent of the AS 315. The service layer 330 may identify the PDU set 310 and provide the PDU set 310 to the RAN, e.g., to the network entity 105-a via an N3 interface. The service layer may also signal PDU set metadata 355 to the RAN (e.g., the network entity 105-a) along with the PDU set 310 (e.g., with the IP packets 345 of the PDU set 310 associated with the PDU set metadata 350). That is, the PDU set metadata 355 may refer to metadata that is routed via the N3 interface to the network entity 105-a.

The network entity 105-a may obtain the PDU set 310 and the PDU set metadata 355. The PDU set schedule control unit 335 of the network entity 105-a may utilize the PDU set metadata 355 to enable the scheduler 340 of the network entity 105-a to schedule transmission of the PDU set 310 to the UE 115-b. The network entity 105-a may, based on the scheduling, transmit the PDU set 310 and the PDU set metadata 360 to the UE 115-b via a Uu interface. The UE 115-b may process (e.g., decode) the received PDU set 310 based on (e.g., utilizing, in accordance with) the PDU set metadata 360.

Some exemplary PDU set metadata fields are listed in Table 1.

TABLE 1
PDU Set Metadata Elements

| Element | Description |
|---|---|
| PDU Set-Based Service Flow | Signals whether an IP packet belongs to |
| Flag | a PDU set-based service flow |
| PDU Set Sequence Number | Running number that identifies a PDU set |
| | that an IP packet belongs to |
| PDU Set Burst Number | Running number that identifies a burst of |
| | a PDU set that an IP packet belongs to |
| PDU Set Size | Number of bits in a PDU set |
| Number of IP Packets | Number of IP packets in a PDU set |
| IP Sequence Number | Number that unambiguously identifies an |
| | IP packet inside a PDU set |
| PDU Set Content Policy | Minimum % of PDU set bits required for |
| | successful PDU set delivery when PDU |
| | set is FEC-protected. Some applications |
| | can use dynamic FEC |
| PDU Set Discard Time | Maximum time that a PDU set can be |
| | waiting for transmission at source |
| | before being discarded |

In some examples, an application layer may use all PDUs in a PDU set 310 to use the corresponding unit of information (and may be unable to use the corresponding unit of information if at least one PDU of the PDU set 310 is missing). In some other aspects, the application layer may still recover parts of the corresponding information unit if some PDUs of the PDU set 310 are missing. Further, in some cases, information in a PDU set 310 may refer to (e.g., be associated with) information in one or more other PDU sets 310, such that an application layer may use the one or more other PDU sets 310 to obtain the information in the PDU set 310 or may not be able to recover the information in the PDU set 310 if the one or more other PDU sets 310 are unavailable. For example, if the PDU set 310-a depends on the PDU set 310-b, but the UE 115-b fails to successfully receive or decode the PDU set 310-b, the UE 115-b may not be able to recover the PDU set 310-a.

A PDU set 310 may include or be an example of a type of frame, and the type of frame may define whether the PDU set 310 depends on one or more other PDU sets 310. For example, a first PDU set 310 may be an example of an I-frame that consists only of information units (e.g., macroblocks) that use intra-prediction (e.g., information units within the first PDU set 310 may only refer to information units that are also within the first PDU set 310), which may also be referred to as spatial prediction or spatial redundancy. That is, information units within the first PDU set 310 may be processed (e.g., encoded or compressed) according to spatial prediction techniques. An I-frame may be self-decodable, in that an I-frame may be decoded (e.g., by a device, an application layer, a functionality, etc.) without utilizing or relying on any other frames. Thus, an I-frame may be considered an independent frame, as it does not depend on other frames for processing.

A second PDU set 310 may be an example of a P-frame, in which information units (e.g., macroblocks) are processed (e.g., encoded or compressed) using temporal prediction and spatial prediction. Information units within a P-frame may refer to information units within a frame that has been previously encoded. As an illustrative example, the PDU set 310-a may be an example of an I-frame and the PDU set 310-b may be an example of a P-frame, where information within the PDU set 310-b refers to (e.g., depends on) the PDU set 310-a.

A third PDU set 310 may be an example of a B-frame, which may include information units (e.g., macroblocks) that are processed (e.g., encoded or compressed) using both temporal prediction and spatial prediction. B-frames may differ from P-frames in that a B-frame may refer to and interpolate from frames that occur before and after the B-frame in the time domain, e.g., using forward prediction and backward prediction, respectively. For example, the PDU set 310-c may be an example of a B-frame. Information included in the PDU set 310-c may depend on the PDU set 310-b (e.g., occurring before the PDU set 310-c in time) and on the PDU set 310-d (e.g., occurring after the PDU set 310-c in time), such that the UE 115-b may decode the PDU set 310-c using the PDU set 310-b and the PDU set 310-d. Put another way, the UE 115-b may obtain the information included in the PDU set 310-c only by successfully decoding and obtaining information included in both the PDU set 310-b and the PDU set 310-d.

A PDU set 310 on which one or more other PDU sets 310 depend (e.g., for encoding and decoding) may be referred to as a “parent” PDU set. A PDU set 310 that depends on one or more other PDU sets 310 may be referred to as a “child” PDU set. A PDU set dependency pattern may represent dependencies between respective PDU sets of a group of PDU sets. For example, a PDU set dependency pattern may indicate, for each PDU set in the PDU set, whether the PDU set is a child or a parent. In some cases, the PDU set dependency pattern may indicate which PDU set(s) depend on each PDU set. For example, a PDU set dependency pattern associated with the PDU sets 310 illustrated in FIG. 3 may indicate that the PDU set 310-b and the PDU set 310-c depend on the PDU set 310-a. Additionally, or alternatively, the PDU set dependency pattern may indicate a frame type associated with (e.g., included in) each PDU set, such that dependencies between PDU sets may be inferred based on the corresponding frame types. In some cases, dependency between PDU sets may repeat periodically. For instance, a group of five PDU sets may depend on one another according to a PDU set dependency pattern that repeats every five PDU sets.

A device or functionality that generates and outputs PDU sets may additionally indicate a PDU set dependency pattern that corresponds to the PDU sets. In some cases, the device or functionality may indicate the PDU set dependency pattern via a control plane message, which may be communicated separately from the associated PDU sets provided via the user plane. For instance, if the PDU set dependency pattern repeats periodically, or changes relatively infrequently, the device or functionality may semi-statically indicate the PDU set dependency pattern via the control plane. The indication of the PDU set dependency pattern may include or be an example of a bitmap indicating a relationship (e.g., a dependency) between respective PDU sets. In other examples, the device or functionality may semi-statically indicate the PDU set dependency pattern via the user plane, such as within metadata of one or more associated PDU sets. For example, the device or functionality may indicate the PDU set dependency pattern within PDU set metadata of each PDU set of the first instance or occurrence of the PDU set dependency pattern, or within PDU set metadata of the first PDU set of the PDU set dependency pattern.

Alternatively, the device or functionality may indicate the PDU set dependency pattern dynamically, such as in metadata of the associated PDU sets. Here, the PDU set dependency pattern may change relatively frequently. The indication of the PDU set dependency pattern may be included in metadata of child PDU sets (e.g., for each child PDU set, the PDU set dependency pattern may indicate the corresponding parent PDU set) or in metadata of parent PDU sets (e.g., for each parent PDU set, the PDU set dependency pattern may indicate which child PDU sets depend on the parent PDU set). For instance, a single bit in each PDU set metadata may indicate whether the respective PDU set is dependent on the previous PDU set, or whether the respective PDU set is a parent PDU set to the subsequent PDU set. Alternatively, the single bit may indicate whether the respective PDU set is a P-frame (and is therefore a child PDU set that depends on the previous PDU set) or is an I-frame (and is therefore a parent PDU set on which the subsequent PDU set depends).

In some cases, the device or functionality may utilize a combination of semi-static signaling via the control plane and dynamic signaling via the user plane. For example, the device or functionality may semi-statically indicate the PDU set dependency pattern via control signaling and may dynamically indicate a start of the PDU set dependency pattern via user plane signaling (e.g., along with the PDU sets), such as within metadata of one or more associated PDU sets (e.g., a subset of the PDU sets). The start of the PDU set dependency pattern may be indicated in the metadata when the PDU set dependency pattern is implemented (e.g., at the start of the PDU set dependency pattern) and, in some examples, if an error occurs (e.g., failure to receive or decode one or more associated PDU sets) and the PDU set dependency pattern needs to be restarted.

In some examples, the PDU set dependency pattern may further indicate (e.g., in PDU set metadata) a respective PDU set sequence number for each PDU set, a respective QFI for each PDU set, or a combination thereof. For instance, the PDU set dependency pattern may indicate, per PDU set, the PDU set sequence numbers and QFIs of each corresponding parent PDU set or child PDU set. In some cases, the PDU set dependency pattern may indicate QFI information only for PDU sets associated with different QoS flows.

The PDU set dependency pattern may be understood as a representation of relative importance levels (e.g., priority levels) for each PDU set. For example, PDU sets on which other PDU sets depend (e.g., parent PDU sets, I-frames) may be considered as relatively higher priority or importance compared to child PDU sets (e.g., P-frames, B-frames). Accordingly, a device or functionality may handle PDU sets based on priorities indicated by the PDU set dependency pattern (e.g., for each PDU set). A device or functionality may, for instance, output parent PDU sets before outputting child PDU sets, or may schedule parent PDU sets with a more robust MCS (e.g., to improve likelihood of successful reception of the parent PDU sets). Additionally, or alternatively, PDU sets with lower importance levels may be dropped or discarded before PDU sets with higher importance levels.

In some cases, importance levels for PDU sets may be configured or authorized by the application generating the PDU sets (such as the AS 315) and may depend on a service or service type associated with the PDU sets. In some XR services, P-frames and B-frames may have an importance level equal to I-frames to support fluent video flow, as dropping P-frames or B-frames may introduce jitter and negatively impact user experience. In other XR services, however, P-frames and B-frames may be used to enhance high definition (e.g., from 720 pixels to 1080 pixels), and dropping P-frames or B-frames may maintain service flow in scenarios where not all service data can be transmitted. Thus, in such scenarios, P-frames and B-frames may have lower importance levels.

In the example illustrated by FIG. 3, the AS 315 may provide an indication of a PDU set dependency pattern associated with the PDU sets 310 (e.g., the PDU sets 310-a through 310-f) communicated to the UPF 325. The PDU set dependency pattern may indicate relationships between PDU sets 310. For example, the PDU set dependency pattern may indicate which, if any, PDU sets 310 depend on each PDU set 310, or may indicate which, if any, PDU sets 310 a given PDU set 310 is dependent on. In some cases, the AS 315 may provide the PDU set dependency pattern indication via control plane signaling. In such cases, the PDU set dependency pattern may be indicated as one or more bitmaps. Each PDU set 310 may correspond to a bitmap indicating dependency relationships with other PDU sets 310 for the PDU set 310. Each bitmap may have a length equal to a quantity of PDU sets 310, where each bit corresponds to a PDU set 310 other than the PDU set 310 with which the bitmap is associated. A value of each bit may indicate whether the PDU set 310 associated with the bitmap has a dependency relationship with the PDU set 310 corresponding to the bit. For example, a bitmap associated with the PDU set 310-a may include six bits, where the second bit corresponds to the PDU set 310-b, the third bit corresponds to the PDU set 310-c, and so on. A value of one may indicate that the corresponding PDU set 310 has a dependency relationship with the PDU set 310-a (e.g., the PDU set 310 is dependent on the PDU set 310-a or the PDU set 310-a is dependent on the PDU set 310), while a value of zero may indicate that the corresponding PDU set 310 does not have a dependency relationship with the PDU set 310-a.

The AS 315 may provide the PDU sets 310 to the UPF 325 via a user plane. The UPF 325 may relay the PDU sets 310 (e.g., via the user plane) to the network entity 105-a, and may transmit the PDU sets 310 (e.g., via the user plane) to the UE 115-b.

In another example, the AS 315 may indicate the PDU set dependency pattern for the PDU sets 310 via the user plane (e.g., semi-statically or dynamically), such as within metadata of one or more of the PDU sets 310 that is transmitted with the PDU sets 310 in the user plane. In any example, each device or functionality (e.g., the UPF 325, the network entity 105-a, the UE 115-b) receiving the PDU sets 310 (e.g., via the user plane) may decode the PDU sets 310 according to the PDU set dependency pattern. For example, if the UE 115-b fails to receive or decode the PDU set 310-b, the UE 115-b may discard (e.g., refrain from decoding) the PDU set 310-c and any other PDU sets 310 that depend on the PDU set 310-b. Additionally, or alternatively, if the network entity 105-a (e.g., or any transmitting device or functionality) determines that the UE 115-b has failed to receive or decode the PDU set 310-b, the network entity 105-a may refrain from transmitting the PDU set 310-c and any other PDU sets 310 that depend on the PDU set 310-b.

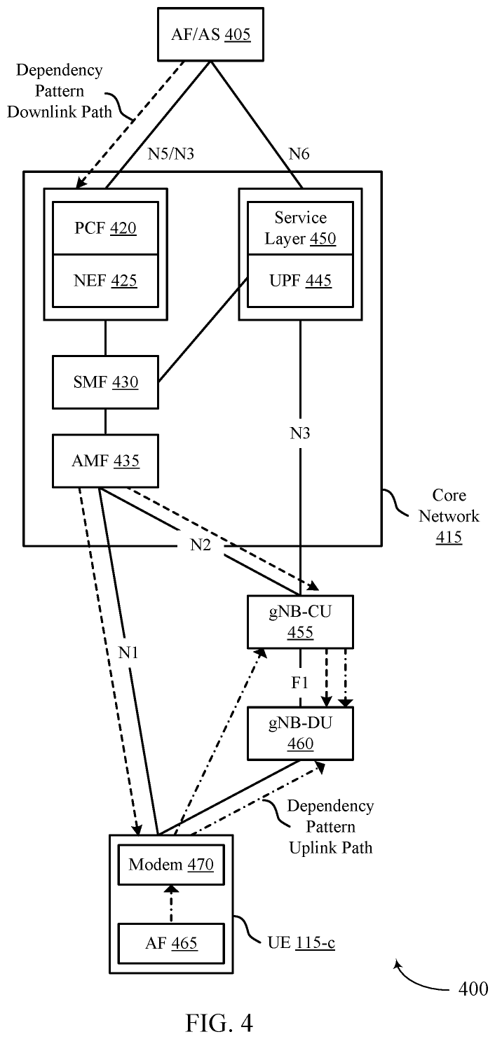

FIG. 4 illustrates an example of a network diagram 400 that supports dependency in PDU set metadata in accordance with one or more aspects of the present disclosure. The network diagram 400 may implement or be implemented to realize aspects of the wireless communications system 100, the network architecture 200, or the wireless communications system 300. For example, the network diagram 400 illustrates communication between an AF/AS 405, various network entities or network functionalities, and a UE 115-c, which may be examples of corresponding devices as described herein, including with reference to FIG. 1. The various network entities or functionalities illustrated by the network diagram 400 include a core network 415 (which may be an example of a 5G core network), a PCF 420, a network exposure function (NEF) 425, an SMF 430, an access and mobility function (AMF) 435, a UPF 445, a service layer 450, a gNB-CU 455, a gNB-DU 460, and the UE 115-c. The UE 115-c may include an AF 465 and a modem 470. In some cases, the gNB-CU 455 and the gNB-DU 460 may be located at a same network node, such as a network entity 105. In some examples, the AF/AS 405 may be associated with video applications (e.g., XR), audio applications, or the like, among other examples.

The AF/AS 405, the various network entities or network functionalities, and the UE 115-c may generate and exchange (e.g., transmit or receive) data as PDU sets (e.g., data packets) via the user plane. For example, for downlink communications, the AF/AS 405 may generate PDU sets to provide to the UPF 445 of the core network 415 via an N6 interface. The UPF 445 may provide the PDU sets to a RAN, such as the network node, via an N3 interface. For example, the UPF 445 may provide the PDU sets to the gNB-CU 455, which may, in turn, provide the PDU sets to the gNB-DU 460 via an F1 interface. The gNB-DU 460 may schedule the PDU sets for transmission to the UE 115-c. For uplink communications, the AF 465 of the UE 115-c may generate PDU sets. The AF 465 may provide the PDU sets to the modem 470 of the UE 115-c for transmission to the network node. For example, the UE 115-c may transmit the PDU sets to the gNB-DU via the user plane.

Control signaling may be communicated between the AF/AS 405, the various network entities or network functionalities, and the UE 115-c via the control plane. In some examples, the control plane may be between the AF/AS 405 and the UE 115-c via one or more of the PCF 420, NEF 425, SMF 430, and AMF 435. In the downlink, the AF/AS 405 may output control signaling to the PCF 420 and the NEF 425 via an N5 or N3 interface. The NEF 425 may provide the control signaling to the SMF 430 and the AMF 435, which may then route the control signaling to the network node (e.g., to the gNB-CU 455) via an N2 interface or to the UE 115-c via an N1 interface. If signaled via the control plane, the dependency pattern may be included in one or more session management messages from the SMF 430 to the UE 115-c. In uplink communications, the UE 115-c may transmit control messages (e.g., RRC signaling, MAC-CE, UCI) to the gNB-CU 455 via the Uu interface.

The network diagram 400 illustrates example communication paths for signaling indications of a PDU set dependency pattern via the control plane in accordance with the techniques described herein. As described with reference to FIG. 3, a PDU set dependency pattern for a group of PDU sets may be indicated semi-statically via the control plane. For example, each of the AF/AS 405, the various network entities or network functionalities, and the UE 115-c may indicate a PDU set dependency pattern as one or more bitmaps within control signaling. More specifically, a device or functionality of the network diagram 400 may generate and output a group of PDU sets to be communicated via the user plane, and may indicate one or more PDU set dependency patterns associated with the group of PDU sets via the control plane.

The indication of the PDU set dependency pattern may include or be an example of one or more bitmaps, where each bitmap is associated with a respective PDU set. A bitmap associated with a PDU set may have a length (e.g., in bits) equal to the quantity of PDU sets in the group of PDU sets, and may include, for each PDU set of the group of PDU sets, one bit indicating whether each PDU set has a dependency relationship with the PDU set (e.g., for processing, encoding, decoding, or the like). For example, for a bitmap associated with a PDU set i of a group of n PDU sets, the bitmap may include n bits. A value of the j^{th} bit may represent the dependency of the PDU set i to the PDU set j (e.g., a value of zero may represent no dependency and a value of one may represent a dependency).

A device or functionality receiving or otherwise obtaining the indication of the PDU set dependency pattern may not be aware of when the PDU set dependency pattern starts and thus may not know when to apply the PDU set dependency pattern (e.g., for processing PDU sets). Accordingly, in some examples, a device or functionality outputting PDU sets and the PDU set dependency pattern may further indicate a start of the PDU set dependency pattern, for example, in PDU set metadata of one or more associated PDU sets. For instance, PDU set metadata for a PDU set of the group of PDU sets may include a single bit indicating that the PDU set is the first PDU set of the PDU set dependency pattern. The PDU set dependency pattern may repeat itself, so that the start of the PDU set is indicated semi-statically. That is, the start of the PDU set dependency pattern may be indicated upon establishment or commencement of the PDU set dependency pattern or if the PDU set dependency pattern needs to be restarted, e.g., due to an error.

In some examples of downlink communications, the indication of the PDU set dependency pattern may be provided by the AF/AS 405 to the network node and to the UE 115-c by way of various network (e.g., 5G system) control plane interfaces. As illustrated, the AF/AS 405 may provide (e.g., output, transmit, communicate) the PDU set dependency pattern to the PCF 420 and the NEF 425 via the NF/N3 interface. The PCF 420 and the NEF 425 may, in turn, provide the PDU set dependency pattern to the SMF 430 or optionally, the AMF 435. For example, the SMF 430 may generate an SMF message such as a session management message, which includes the PDU set dependency pattern, and output the message including the PDU set dependency pattern to the AMF 435. The AMF 435 may output or transmit the message to the UE 115-c via the N1 interface. Additionally, or alternatively, the AMF 435 may output the PDU set dependency pattern to the RAN. For instance, the AMF 435 may output the PDU set dependency pattern to the gNB-DU 460 by way of the gNB-CU 455 (e.g., via the N2 interface). In some cases, the gNB-DU 460 may transmit the PDU set dependency pattern to the UE 115-c.

In some cases, the network node may schedule transmission of PDU sets based on the associated PDU set dependency pattern. The PDU set dependency pattern may indicate (e.g., implicitly or explicitly) relative priority levels for each PDU set. The network node may prioritize scheduling PDU sets that have a higher priority level (e.g., I-frames, parent PDU sets) over PDU sets of a lower priority level (e.g., P-frames, B-frames, child PDU sets). For example, the network node may schedule higher priority PDU sets to be transmitted (e.g., to the UE 115-c) according to transmission parameters associated with improved reliability and robustness, or may schedule higher priority PDU sets to be transmitted prior to lower priority PDU sets.

In uplink communications, PDU sets may be generated at the AF 465 of the UE 115-c (e.g., may be generated by an application of the UE 115-c). The AF 465 may provide the indication of the PDU set dependency pattern to the modem 470 of the UE 115-c. Additionally, or alternatively, the UE 115-c may provide the indication of the PDU set dependency pattern to the network node via control signaling. In a first example, the UE 115-c may transmit an RRC message indicating the PDU set dependency pattern to the gNB-CU 455 and the gNB-CU 455 may provide the PDU set dependency pattern to the gNB-DU 460. In a second example, the UE 115-c may transmit a MAC-CE indicating the PDU set dependency pattern directly to the gNB-DU 460.

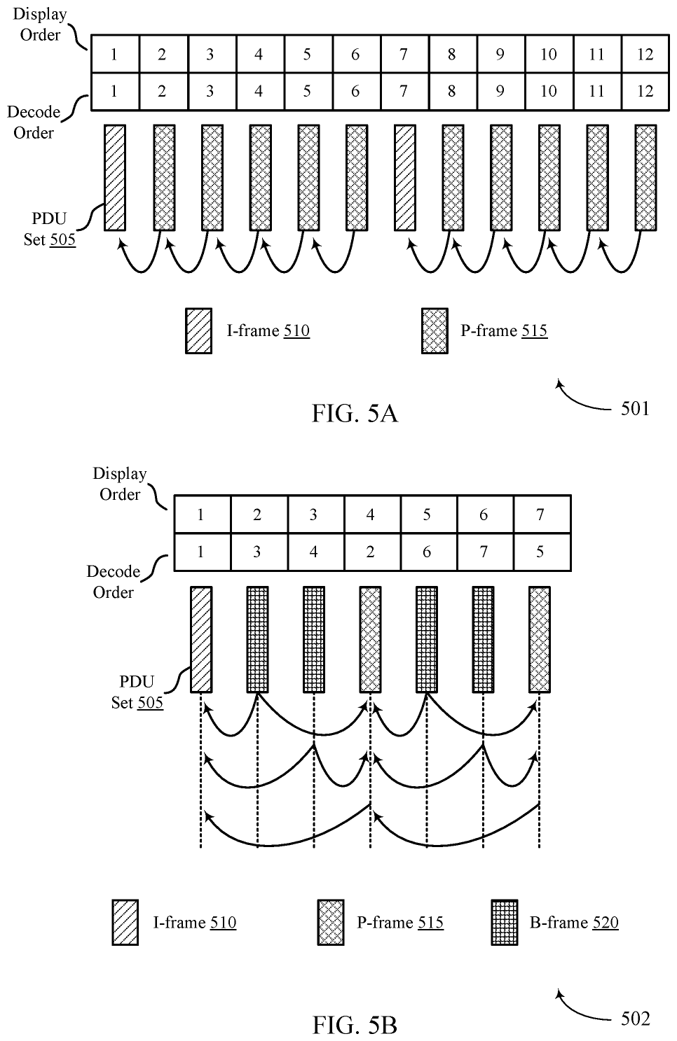

FIGS. 5A and 5B illustrate examples of a PDU set dependency pattern 501 and a PDU set dependency pattern 502, respectively, that support dependency in PDU set metadata in accordance with one or more aspects of the present disclosure. The PDU set dependency pattern 501 and the PDU set dependency pattern 502 may implement or be implemented by aspects of the wireless communications system 100, the network architecture 200, the wireless communications system 300, or the network diagram 400. For example, the PDU set dependency patterns 501 and 502 illustrate relationships between PDU sets 505 of a group of PDU sets communicated between devices or functionalities as described herein. A PDU set 505 may also be referred to as a frame. For example, the PDU sets 505 may include or be examples of I-frames 510, P-frames 515, and B-frames 520.

A device or functionality may provide an indication of the PDU set dependency pattern 501 or the PDU set dependency pattern 502 via control plane signaling or as part of metadata provided with the associated PDU sets 505. For example, a device or functionality may indicate the PDU set dependency pattern 501 or the PDU set dependency pattern 502 semi-statically via the control plane as described with reference to FIG. 4. In other examples, the device or functionality may indicate the PDU set dependency pattern 501 or the PDU set dependency pattern 502 semi-statically via the user plane, e.g., within PDU set metadata of a subset of PDU sets 505. In still other examples, the device or functionality may indicate the PDU set dependency pattern 501 or the PDU set dependency pattern 502 dynamically via the user plane, where information related to the PDU set dependency pattern is included in PDU set metadata of each PDU set 505.

The dependency relationship between PDU sets 505 may relate to an order in which PDU sets 505 are encoded or decoded (e.g., an order in which PDU sets 505 are provided to an encoder or decoder). Each PDU set 505 may be associated with a PDU set sequence number, which may correspond to the decode order. For instance, in FIG. 5A, the first PDU set 505 may have a PDU set sequence number of 1 and may be referred to as PDU set 1, the second PDU set may have a PDU set sequence number of 2 and may be referred to as PDU set 2, and so on. For some applications or services, such as video applications, frames (e.g., PDU sets 505) may be displayed to a user according to a display order, which may be the same as or different from a decode order. A P-frame 515 (e.g., information in a P-frame 515) may depend on a frame that was encoded/decoded before (e.g., prior to) the P-frame 515, as information in the P-frame 515 may refer to information in the previous frame. For a group of PDU sets 505 that includes only I-frames 510 and P-frames, the display order and the decode order may be the same, as illustrated in FIG. 5A. A given P-frame 515 may only refer to (e.g., depend on) the previous frame. In the example of FIG. 5A, each I-frame 510 may be considered a parent PDU set, while each P-frame 515 may be considered a child PDU set.

For semi-static signaling, a PDU set dependency pattern (e.g., the PDU set dependency pattern 501 or the PDU set dependency pattern 502) may be indicated in PDU set metadata of a subset of PDU sets 505 of the group of PDU sets 505. The group of PDU sets 505 may include all PDU sets 505 associated with the PDU set dependency pattern. In the example of FIG. 5A, the group of PDU sets 505 may include PDU set 1 through PDU set 12, while the PDU set dependency pattern repeats every six PDU sets. In some cases, the PDU set dependency pattern may be indicated in the PDU set metadata of each PDU set 505 of the first (e.g., initial) instance of the PDU set dependency pattern, such as in PDU set 1 through PDU set 6. In such cases, PDU set metadata associated with PDU set 7 through PDU set 12 may not include an indication of the PDU set dependency pattern. Alternatively, the PDU set dependency pattern may be indicated in PDU set metadata associated with only the first PDU set of the PDU set dependency pattern, e.g., PDU set 1. That is, the metadata of PDU set 1 may indicate dependencies between PDU sets for each of the PDU sets 1 through 12.

In some cases, a single bit in PDU set metadata may indicate that the PDU set dependency pattern is to start or to be restarted. This bit may be included as part of the indication of the PDU set dependency pattern or may be dynamically signaled within any PDU set metadata. For example, if an error occurs at PDU set 5, PDU set metadata of PDU set 6 may include a bit indicating to restart the PDU set dependency pattern at PDU set 7.

When the PDU set dependency pattern changes relatively frequently, or does not repeat itself (as in the example of FIG. 5A), the PDU set dependency pattern may be indicated dynamically in the PDU set metadata of each PDU set 505 of the group of PDU sets 505. For example, the PDU set metadata of each PDU set 505 may indicate whether the PDU set 505 depends on the previous PDU set 505, or may indicate whether the previous PDU set 505 depends on the PDU set 505. Put another way, dependency information may be indicated in child PDU sets or in parent PDU sets.

In a first example, the PDU set dependency pattern may be indicated by including dependency information in child PDU sets. Here, the metadata for each PDU set may indicate a relationship between the PDU set and the previous PDU set. In some cases, the relationship may be indicated as a single bit, where a value of the bit indicates whether the PDU set is dependent on the previous PDU set. A value of 1 may indicate that the PDU set is dependent on the previous PDU set, while a value of 0 may indicate no dependency. In some examples, the PDU set may be dependent on the previous PDU set based on a frame type of the PDU set. For example, in FIG. 5A, PDU set 7 may be an I-frame 510 and thus may not depend on the previous PDU set (e.g., PDU set 6); as such, the metadata of PDU set 7 may indicate a bit with a value of 0. PDU set 8 may be a P-frame 515 and may depend on PDU set 7, such that the metadata of PDU set 8 may indicate a bit with a value of 1.

In a second example, the PDU set dependency pattern may be indicated by including dependency information in parent PDU sets. The metadata for each PDU set may indicate a relationship between the PDU set and the subsequent PDU set, e.g., based on a frame type of the PDU set. For example, in FIG. 5A, the metadata for PDU set 7 may indicate (e.g., with a bit value of 1) that the subsequent PDU set, PDU set 8, depends on the PDU set 7. Alternatively, the metadata for PDU set 6 may indicate (e.g., with a bit value of 0) that PDU set 7 does not depend on PDU set 6. Table 2 illustrates example dependency indications included in metadata for both the first example (e.g., indicated in child PDU sets) and the second example (e.g., indicated in parent PDU sets).

TABLE 2
Bit Values in PDU Set Metadata

| PDU Set | | |
|---|---|---|
| Sequence | Indication in | Indication in |
| Number | Child | Parent |
| 1 | 0 | 1 |
| 2 | 1 | 1 |
| 3 | 1 | 1 |
| . . . | | |
| 6 | 1 | 0 |
| 7 | 0 | 1 |
| 8 | 1 | 1 |

A single bit may be used to indicate dependency in child PDU sets or parent PDU sets for relatively simple patterns, such as those including only I-frames 510 and P-frames 515. Additionally, or alternatively, a single bit in PDU set metadata may indicate a frame type for the associated PDU set. A value of the bit may indicate whether the associated PDU set is an I-frame 510 or a P-frame 515, which may, in turn, implicitly indicate whether the associated PDU set is dependent on the previous PDU set (e.g., because a P-frame 515 will depend on a previous PDU set, while an I-frame 510 will not). A device or functionality may thus infer the PDU set dependency pattern for the PDU sets 505 based on the frame types.

The PDU sets 505 of the group of PDU sets may be associated with a same traffic flow (i.e., service flow). In some cases, the PDU sets 505 may additionally be mapped to a same QoS flow, while in other cases, different PDU sets 505 may be mapped to different QoS flows. For instance, I-frames 510 may be mapped to a first QoS flow (e.g., based on I-frames 510 being associated with a relatively high importance or priority level), while P-frames 515 may be mapped to a second QoS flow different from the first QoS flow. In such cases, the PDU set dependency pattern may further indicate a QFI associated with each PDU set 505. For example, the PDU set metadata for each PDU set 505 may indicate the QFI for dependent PDU sets. That is, the PDU set metadata may include, in each parent PDU set, a single bit to indicate a dependency with the subsequent PDU set, as well as a QFI for the subsequent PDU set.

Some PDU set dependency patterns may be relatively more complex. For example, some parent PDU sets may have multiple child PDU sets, or a child PDU set may depend on multiple parent PDU sets. Thus, the PDU set dependency pattern may be indicated by more than a single bit. In some examples, the PDU set dependency pattern may explicitly indicate which PDU sets are dependent on a parent PDU set, or which PDU sets a child PDU set depends on. When PDU sets of a same service flow are mapped to the same QoS flow, the indication of the PDU set dependency pattern may include the PDU set sequence number of the parent PDU set(s) (e.g., for signaling the PDU set dependency pattern in child PDU sets) or may include the PDU set sequence number of the child PDU set(s) (e.g., for signaling the PDU set dependency pattern in parent PDU sets). Table 3 illustrates examples of indicating PDU set sequence numbers in PDU set metadata for the group of PDU sets 505 of FIG. 5A.

TABLE 3
PDU Set Sequence Numbers in PDU Set Metadata

| PDU Set | | |
|---|---|---|
| Sequence | Indication in | Indication in |
| Number | Child | Parent |
| 1 | — | 2 |
| 2 | 1 | 3 |
| 3 | 2 | 4 |
| . . . | | |
| 6 | 5 | — |
| 7 | — | 8 |
| 8 | 7 | 9 |
| . . . | | |
| 11 | 10 | 12 |
| 12 | 11 | — |

A PDU set sequence number may be indicated as an absolute value (e.g., may be explicitly indicated), a relative value, or a bitmap. For example, metadata for a parent PDU set with a PDU set sequence number a may indicate the PDU set sequence number b for a child PDU set b. In the example of an absolute value indication, the PDU set metadata for PDU set a may indicate a value of b. For relative value indications, the PDU set metadata may indicate a value of the PDU set sequence number for the child PDU set b relative to the PDU set sequence number for the parent PDU set, such that the PDU set metadata may indicate a value of b−a. The bitmap may include a respective bit indicating whether each PDU set of the group of PDU sets is dependent on the PDU set a. For instance, the (b−a)^{th} bit of the bitmap may be set to a value of 1 to indicate that the PDU set b is dependent on the PDU set a.

A group of PDU sets 505 that includes B-frames 520 may be associated with relatively more complex PDU set dependency patterns, as a B-frame 520 may refer to multiple frames that occur (e.g., are encoded/decoded) before or after the B-frame 520. For example, as illustrated in FIG. 5B, a B-frame 520 may depend on an I-frame 510 or a P-frame 515 that was decoded before the B-frame 520, as well as on a P-frame 515 decoded after the B-frame 520. In such cases, the display order may differ from the decode order. The device or functionality may place decoded PDU sets 505 in a buffer until the PDU sets 505 are to be displayed.

In the example of FIG. 5B, a PDU set 505 may have a dependency relationship with multiple other PDU sets 505. Put another way, a parent PDU set may have multiple child PDU sets that depend on the parent PDU set, or a child PDU set may depend on multiple parent PDU sets. For example, one or both of an I-frame 510 and a P-frame 515 may be considered a parent PDU set to a B-frame 520. A B-frame 520 may be considered a child PDU set. Table 4 illustrates examples of indicating PDU set sequence numbers in PDU set metadata for the group of PDU sets 505 of FIG. 5.

TABLE 4
PDU Set Sequence Numbers in PDU Set Metadata

| PDU Set | | |
|---|---|---|
| Sequence | Indication in | Indication in |
| Number | Parent | Child |
| 1 | 2, 3, 4 | — |
| 2 | 3, 4, 5, 6, 7 | 1 |
| 3 | — | 1, 2 |
| 4 | — | 1, 2 |
| 5 | 6, 7 | 2 |
| 6 | — | 2, 5 |
| 7 | — | 2, 5 |

When PDU sets of the same service flow are mapped to different QoS flows, the indication of the PDU set dependency pattern may include the PDU set sequence number as well as the QFI for each indicated PDU set. For example, if the PDU set dependency pattern is indicated in child PDU sets, the metadata of each child PDU set may indicate respective PDU set sequence numbers and QFIs for each parent PDU set. If the PDU set dependency pattern is indicated in parent PDU sets, the metadata of each parent PDU set may indicate respective PDU set sequence numbers and QFIs for each child PDU set.

A QFI may be indicated as an absolute value (e.g., may be explicitly indicated), a relative value, or a bitmap. For example, the PDU set 1 in FIG. 5B may have three child PDU sets, e.g., the PDU set 2, the PDU set 3, and the PDU set 4. The PDU set 2 and the PDU set 3 may be associated with a first QoS having a QFI 1, while the PDU set 4 may be associated with a second QoS having a QFI 2. The metadata of the PDU set 1 (e.g., the parent PDU set) may explicitly indicate a list of QFIs including the respective QFI associated with each child PDU set (e.g., [QFI 1, QFI 1, QFI 2]). Alternatively, the metadata of the PDU set 1 may indicate a list of QFIs associated with the child PDU sets. That is, the list may include QFIs that are common to the child PDU sets (e.g., [QFI 1, QFI 2]) rather than explicitly indicating the QFI for each PDU set. In other examples, the metadata of the PDU set 1 may indicate a QFI bitmap, where each bit of the bitmap corresponds to a respective QFI. Thus, a value of each bit may indicate whether one or more child PDU sets are associated with the corresponding QFI. For example, a bit corresponding to QFI 1 and a bit corresponding to QFI 2 may each be set to a value of 1.

In the latter two examples, the PDU set metadata for PDU set 1 may further indicate a relationship between the PDU set sequence number of each child PDU set and the QFI of each child PDU set. That is, if the indication of QFIs includes a list of QFIs common to the child PDU sets, the device or functionality may not know which child PDU sets are associated with each QFI. The indication of the QFI-PDU set sequence number relationship may, for example, be a list of indexes, where a length of the list (e.g., a quantity of indexes) corresponds to the quantity of PDU set sequence numbers being indicated. For example, the PDU set metadata of PDU set 1 may indicate the PDU set sequence numbers of the child PDU sets as [2, 3, 4], and may indicate the QFIs common to the child PDU sets as [QFI 1, QFI 2] or as a bitmap with the bit corresponding to QFI 1 set to 1 and the bit corresponding to QFI 2 set to 1. The PDU set metadata of PDU set 1 may further indicate the relationship between the PDU set sequence numbers and the QFIs as a list of indexes [1, 1, 2]. Each index in the list may correspond to a PDU set sequence number, and a value of the index may map to an entry in the QFI list or to a bit in the bitmap. For instance, the first index may map to the first indicated PDU set sequence number (e.g., PDU set 2), and the value of the first index (e.g., 1) may map to the first entry in the QFI list (or the first bit in the bitmap). The first entry in the QFI list is QFI 1. Thus, the PDU set corresponding to the PDU set sequence number 2 may be associated with the QFI 1. Similarly, the PDU set 3 may correspond to the QFI 1, while the PDU set 4 may correspond to the QFI 2.

The examples and techniques described herein may be further extended to indicate dependency depths for each PDU set. The dependency depth may also be understood as a recurrent dependency level. A highest dependency depth (HDD) for a given PDU set may refer to a quantity of dependency levels until the highest parent PDU set (also referred to as an ancestor) or until the lowest child PDU set (also referred to as a successor). For example, when signaled in metadata of a parent PDU set, the HDD of the parent PDU set may refer to the quantity of dependency levels until the lowest child PDU set. Alternatively, when signaled in metadata of a child PDU set, the HDD of the child PDU set may refer to the quantity of dependency levels until the highest parent PDU set. For example, in FIG. 5A, the HDD for the PDU set 3 may be equal to 2, as the PDU set 3 depends on the PDU set 2, and the PDU set 2 in turn depends on the PDU set 1. Thus, there are two dependency levels between the PDU set 3 and the highest PDU set (PDU set 1). The PDU set 6 may have an HDD equal to 5, as there are five recurring dependency levels between the PDU set 6 and the highest PDU set (PDU set 1).

In some cases, as the HDD increases, overhead associated with indicating PDU set dependency patterns may also increase. Accordingly, the device or functionality may be configured to limit dependency information included in the PDU set dependency pattern indication. For instance, the device or functionality may be configured to limit the HDD to within a threshold value (e.g., a threshold dependency depth), which may be referred to as an actual dependency depth (ADD). The ADD may be defined as the quantity of dependency levels until the highest ancestor or successor being signaled in the PDU set dependency pattern indication (e.g., in the PDU set metadata of the corresponding PDU set). In some examples, the device or functionality may receive a message (e.g., a control message) indicating the ADD. For uplink communications, the device or functionality may include or be an example of a UE, and the UE may receive a message indicating the ADD.

As an illustrative example, the device or functionality may be configured with an ADD (e.g., a threshold dependency depth) of 3 for one or more PDU sets of the group of PDU sets, and may indicate the ADD for each child PDU set. In the example of FIG. 5A, the ADD indicated in the PDU set metadata of the PDU set 3 may be equal to the HDD of the PDU set 3 (e.g., may be equal to 2), as the PDU set 3 depends on the PDU set 2 and the PDU set 1, and the value of 2 is less than the threshold dependency depth of 3. When the HDD for a PDU set is greater than the threshold dependency depth, however, the device or functionality may limit the dependency information indicated in the metadata of the child PDU set according to the ADD, which may reduce overhead. For instance, the HDD for the PDU set 6 may be equal to 5, but the metadata for the PDU set 6 may only indicate an ADD of 3. That is, the metadata for the PDU set 6 may indicate that the PDU set 6 depends on the PDU set 5, the PDU set 4, and the PDU set 3, although the PDU set 6 further depends on the PDU set 2 and the PDU set 1.

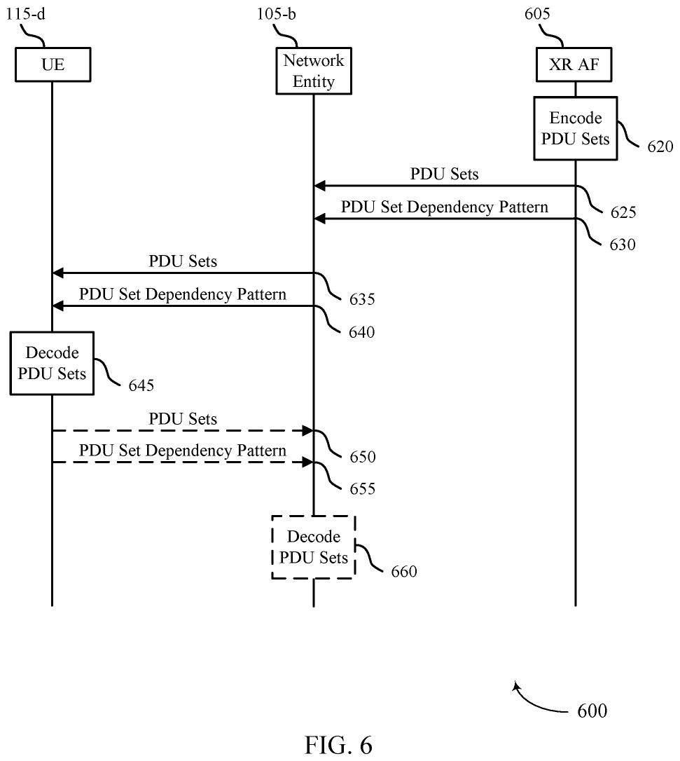

FIG. 6 illustrates an example of a process flow 600 that supports dependency in PDU set metadata in accordance with one or more aspects of the present disclosure. The process flow 600 may implement aspects of the wireless communications system 100, the network architecture 200, the wireless communications system 300, or the network diagram 400. For example, the process flow 600 illustrates communication a UE 115-d, a network entity 105-b, and an XR AF 605, which may be examples of corresponding devices described herein. The UE 115-d may include an AF and a modem. The process flow 600 may illustrate an example of an XR AF 605 generating and providing PDU sets and corresponding PDU set dependency information to a UE 115-d by means of the network entity 105-b.

In the following description of the process flow 600, the operations may be performed (such as reported or provided) in a different order than the order shown, or the operations performed by the example devices may be performed in different orders or at different times. Some operations also may be left out of the process flow 600, or other operations may be added to the process flow 600. Further, although some operations or signaling may be shown to occur at different times for discussion purposes, these operations may actually occur at the same time.

At 620, the XR AF 605 may encode each PDU set of a group of PDU sets based on a PDU set dependency pattern, where each PDU set of the group of PDU sets is associated with a same service flow. The PDU set dependency pattern may indicate a relationship between respective PDU sets of the group of PDU sets for the encoding. For example, the XR AF 605 may encode at least a first PDU set and a second PDU set of the group of PDU sets in accordance with a corresponding relationship indicated by the PDU set dependency pattern. In some examples, the first PDU set may be mapped to a first QoS flow and the second PDU set may be mapped to a second QoS flow.

At 625, the XR AF 605 may output, and the network entity 105-b may obtain, the group of PDU sets via the user plane and based on the encoding.

At 630, the XR AF 605 may output, and the network entity 105-b may obtain, an indication of the PDU set dependency pattern associated with the group of PDU sets. In some cases, the XR AF 605 may output, and the network entity 105-b may obtain, the indication of the PDU set dependency pattern via the user plane, e.g., as part of PDU set metadata associated with at least one PDU set of the group of PDU sets. For example, the XR AF 605 may output, and the network entity 105-b may obtain, the indication of the PDU set dependency pattern as part of PDU metadata associated with the first PDU set, or as part of PDU metadata associated with each PDU set. In such examples, the XR AF 605 may output, and the network entity 105-b may obtain, the indication of the PDU set dependency pattern together with the group of PDU sets signaled at 625 rather than as separate transmissions.

Alternatively, the XR AF 605 may output, and the network entity 105-b may obtain, the indication of the PDU set dependency pattern via the control plane, e.g., separately from the group of PDU sets communicated via the user plane at 625. For example, the XR AF 605 may output, and the network entity 105-b may obtain, a control plane message indicating the PDU set dependency pattern (e.g., as one or more bitmaps associated with the group of PDU sets). In some such examples, the XR AF 605 may include, as part of metadata associated with at least the first PDU set of the group of PDU sets, an indication of a start of the PDU set dependency pattern.

Additionally, or alternatively, the XR AF 605 may indicate, as part of the PDU set dependency pattern, respective PDU sequence numbers for each PDU set of the group of PDU sets. In some cases, the XR AF 605 may explicitly indicate the PDU sequence numbers, while in other cases, the XR AF 605 may indicate a relative value of a PDU sequence number or a bitmap corresponding to a set of relative values of the PDU sequence numbers. In some examples, the indication of the PDU set dependency pattern may further include an indication of a mapping between PDU sequence numbers and QFIs.

In some examples, the indication of the PDU set dependency pattern may include an indication of one or more HDDs for one or more of the PDU sets, one or more ADDs for one or more of the PDU sets, or a combination thereof.

At 635, the network entity 105-b may output, and the UE 115-d may obtain, the group of PDU sets. At 640, the network entity 105-b may output, and the UE 115-d may obtain, the indication of the PDU set dependency pattern. In some examples, the network entity 105-b may output, and the UE 115-d may obtain, the indication of the PDU set dependency pattern via the control plane. For example, the network entity 105-b may indicate the PDU set dependency pattern via a control message, such as RRC signaling, a MAC-CE, or the like. Alternatively, the network entity 105-b may output, and the UE 115-d may obtain, the indication of the PDU set dependency pattern via the user plane, for example, as part of PDU set metadata communicated together with the group of PDU sets at 635.

In some cases, the indication of the PDU set dependency pattern may include respective QFIs associated with each PDU set of the group of PDU sets, e.g., based on a corresponding QoS flow for each PDU set. For example, if the first QoS flow is different from the second QoS flow, the network entity 105-b may indicate, as part of the PDU set dependency pattern, a first QFI associated with the first QoS flow and a second QFI associated with the second QoS flow. For example, the indication of the PDU set dependency pattern may include an explicit list of respective QFIs for each PDU set, an explicit list of QFIs corresponding to the group of PDU sets, or a bitmap corresponding to QFIs common to the group of PDU sets.

At 645, the UE 115-d may process (e.g., decode) each PDU set of the group of PDU sets based on the indication of the PDU set dependency pattern. For example, the UE 115-d may decode at least the first PDU set and the second PDU set based on a dependency between the first PDU set and the second PDU set, e.g., as indicated by the PDU set dependency pattern. In some examples, the UE 115-d may fail to successfully decode one or more PDU sets of the group of PDU sets. In such examples, the UE 115-d may discard any PDU sets that depend on the unsuccessfully decoded PDU set, e.g., according to the PDU set dependency pattern.

In some cases, the UE 115-d may generate and output PDU sets via uplink, e.g., to the network entity 105-b. For example, at 650, the UE 115-d may transmit, and the network entity 105-b may receive, a group of PDU sets. At 655, the UE 115-d may transmit, and the network entity 105-b may receive, an indication of a PDU set dependency pattern associated with the group of PDU sets. In some examples, the UE 115-d may transmit the indication of the PDU set dependency pattern via control signaling, such as an RRC message, a MAC-CE, or the like, to a CU of the network entity 105-b. Alternatively, the UE 115-d may transmit, and the network entity 105-b may receive, the PDU set dependency pattern via the user plane. For instance, the UE 115-d may include the indication of the PDU set dependency pattern as part of PDU set metadata transmitted together with the group of PDU sets to a DU of the network entity 105-b. At 660, the network entity 105-b may process and decode the group of PDU sets in accordance with the indication of the PDU set dependency pattern.

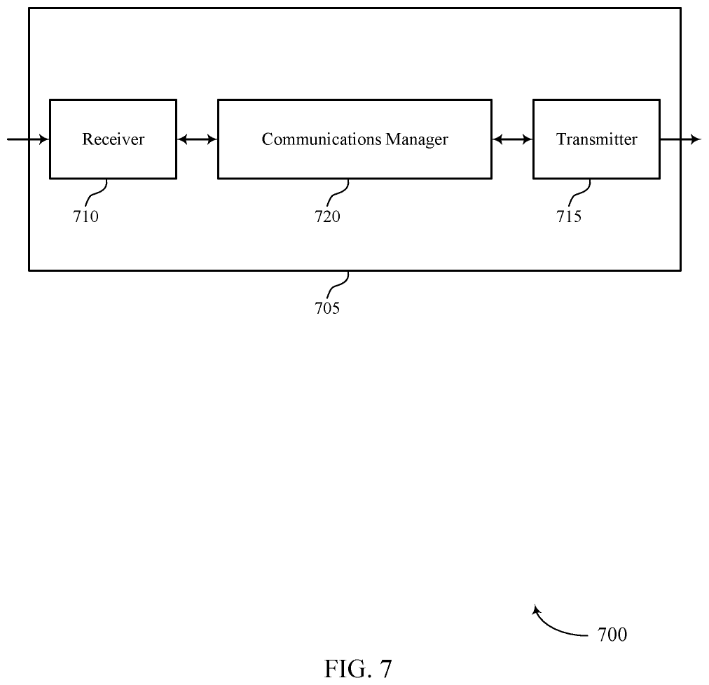

FIG. 7 illustrates a block diagram 700 of a device 705 that supports dependency in PDU set metadata in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to dependency in PDU set metadata). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dependency in PDU set metadata). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of dependency in PDU set metadata as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a wireless device in accordance with examples as disclosed herein. For example, the communications manager 720 may be configured as or otherwise support a means for obtaining an indication of a PDU (PDU) set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The communications manager 720 may be configured as or otherwise support a means for obtaining the second PDU set, where the first PDU set is associated with a first quality of service flow and the second PDU set is associated with a second quality of service flow. The communications manager 720 may be configured as or otherwise support a means for decoding at least the first PDU set and the second PDU set based on the PDU set dependency pattern.

Additionally, or alternatively, the communications manager 720 may support wireless communications at a wireless device in accordance with examples as disclosed herein. For example, the communications manager 720 may be configured as or otherwise support a means for encoding at least a first PDU (PDU) set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The communications manager 720 may be configured as or otherwise support a means for outputting an indication of the PDU set dependency pattern based on the encoding. The communications manager 720 may be configured as or otherwise support a means for outputting the second PDU set, where the first PDU set is associated with a first quality of service flow and the second PDU set is associated with a second quality of service flow.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for improved handling and processing of PDU sets. For example, the device 705 may process PDU sets based on a corresponding PDU set dependency pattern. The device 705 may discard PDU sets that depend on a PDU set that was not successfully received or decoded, which may reduce processing and power consumption. Additionally, the device 705 may handle PDU sets based on a relative importance or priority as indicated by the PDU set dependency pattern, which may provide more efficient utilization of communication resources and improve communications reliability.

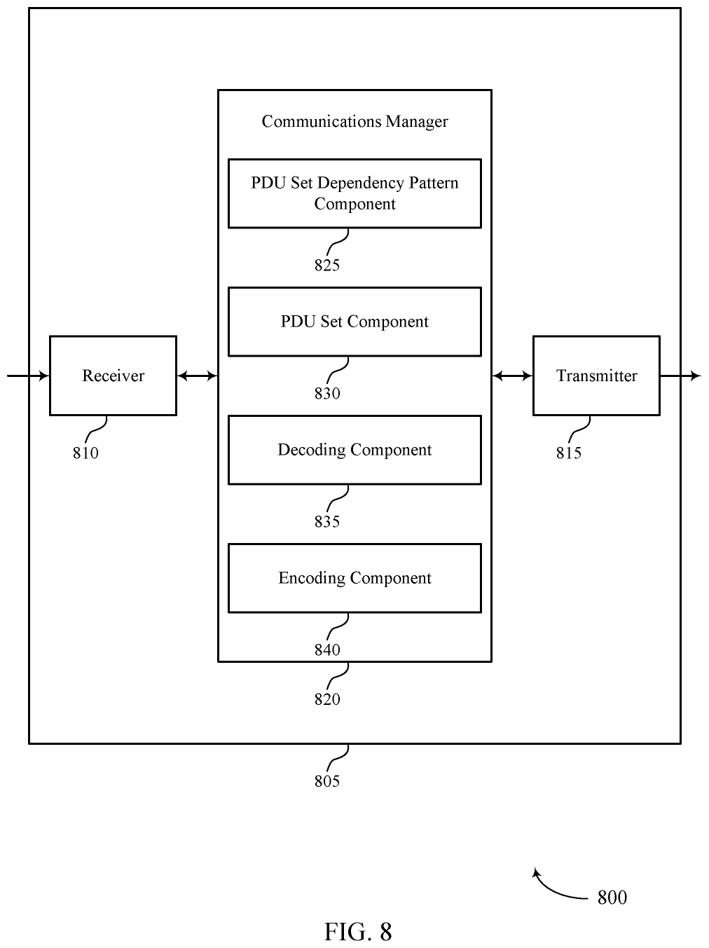

FIG. 8 illustrates a block diagram 800 of a device 805 that supports dependency in PDU set metadata in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to dependency in PDU set metadata). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dependency in PDU set metadata). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of dependency in PDU set metadata as described herein. For example, the communications manager 820 may include a PDU set dependency pattern component 825, a PDU set component 830, a decoding component 835, an encoding component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a wireless device in accordance with examples as disclosed herein. The PDU set dependency pattern component 825 may be configured as or otherwise support a means for obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The PDU set component 830 may be configured as or otherwise support a means for obtaining the second PDU set, where the first PDU set is associated with a first quality of service flow and the second PDU set is associated with a second quality of service flow. The decoding component 835 may be configured as or otherwise support a means for decoding at least the first PDU set and the second PDU set based on the PDU set dependency pattern.

Additionally, or alternatively, the communications manager 820 may support wireless communications at a wireless device in accordance with examples as disclosed herein. The encoding component 840 may be configured as or otherwise support a means for encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The PDU set dependency pattern component 825 may be configured as or otherwise support a means for outputting an indication of the PDU set dependency pattern based on the encoding. The PDU set component 830 may be configured as or otherwise support a means for outputting the second PDU set, where the first PDU set is associated with a first quality of service flow and the second PDU set is associated with a second quality of service flow.

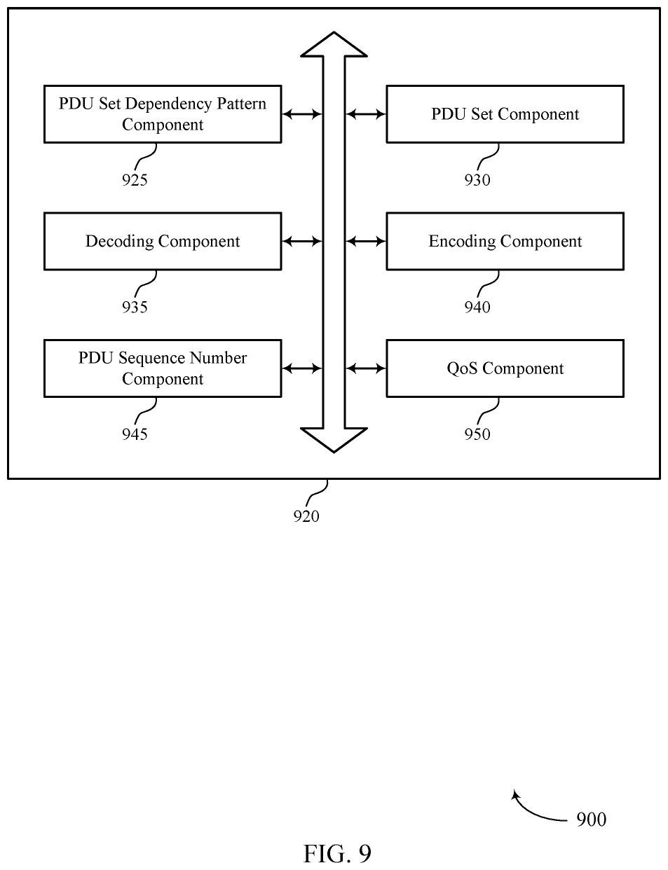

FIG. 9 illustrates a block diagram 900 of a communications manager 920 that supports dependency in PDU set metadata in accordance with one or more aspects of the present disclosure. The communications manager 920 may be an example of aspects of a communications manager 720, a communications manager 820, or both, as described herein. The communications manager 920, or various components thereof, may be an example of means for performing various aspects of dependency in PDU set metadata as described herein. For example, the communications manager 920 may include a PDU set dependency pattern component 925, a PDU set component 930, a decoding component 935, an encoding component 940, a PDU sequence number component 945, a QoS component 950, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications at a wireless device in accordance with examples as disclosed herein. The PDU set dependency pattern component 925 may be configured as or otherwise support a means for obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The PDU set component 930 may be configured as or otherwise support a means for obtaining the second PDU set, where the first PDU set is associated with a first QoS flow and the second PDU set is associated with a second QoS flow. The decoding component 935 may be configured as or otherwise support a means for decoding at least the first PDU set and the second PDU set based on the PDU set dependency pattern.

In some examples, to support obtaining the indication of the PDU set dependency pattern, the PDU set dependency pattern component 925 may be configured as or otherwise support a means for obtaining, via a control plane, a message including the PDU set dependency pattern.

In some examples, the PDU set dependency pattern component 925 may be configured as or otherwise support a means for obtaining, as part of metadata associated with the first PDU set, an indication of a start of the PDU dependency pattern.

In some examples, the indication of the PDU set dependency pattern includes a bitmap associated with the first PDU set having a length equal to a quantity of PDU sets in the group of PDU sets, the bitmap indicating the relationship between the first PDU set and one or more PDU sets of the group of PDU sets. In some examples, each bit of the bitmap corresponds to a respective PDU set of the group of PDU sets. In some examples, a value of each bit indicates whether the respective PDU set is dependent on the first PDU set.

In some examples, to support obtaining the indication of the PDU set dependency pattern, the PDU set dependency pattern component 925 may be configured as or otherwise support a means for obtaining the first PDU set and metadata associated with the first PDU set, the metadata indicating the PDU set dependency pattern. In some examples, the PDU set dependency pattern indicates a relationship between each PDU set in the subset of PDU sets. In some examples, the metadata associated with the first PDU set further indicates that the PDU set dependency pattern is to be restarted.

In some examples, to support obtaining the indication of the PDU set dependency pattern, the PDU set component 930 may be configured as or otherwise support a means for obtaining the first PDU set and first metadata associated with the first PDU set. In some examples, to support obtaining the indication of the PDU set dependency pattern, the PDU set dependency pattern component 925 may be configured as or otherwise support a means for obtaining second metadata associated with the second PDU set, the first metadata and the second metadata indicating the PDU set dependency pattern.

In some examples, a value of a first bit in the first metadata indicates whether the first PDU set is dependent on the second PDU set for the decoding based on a frame type associated with the first PDU set and the second PDU set. In some examples, a value of a second bit in the second metadata indicates whether the second PDU set is dependent on the first PDU set for the decoding based on a frame type associated with the first PDU set and the second PDU set.

In some examples, the first metadata further indicates a QFI for the first QoS flow and the second metadata further indicates a QFI for the second QoS flow, the first QoS flow being different from the second QoS flow.

In some examples, the first metadata further indicates a frame type associated with the first PDU set and the second metadata further indicates a frame type associated with the second PDU set.

In some examples, the second metadata indicates one or more PDU set sequence numbers associated with one or more PDU sets of the group of PDU sets. In some examples, the second PDU set is dependent on the one or more PDU sets of the group of PDU sets for the decoding. In some examples, the second metadata further indicates one or more QFIs associated with the one or more PDU sets of the group of PDU sets based on the first QoS flow being different from the second QoS flow.

In some examples, the first metadata indicates one or more PDU set sequency numbers associated with one or more PDU sets of the group of PDU sets. In some examples, the one or more PDU sets of the group of PDU sets are dependent on the first PDU set for the decoding. In some examples, the first metadata further indicates one or more QFIs associated with the one or more PDU sets of the group of PDU sets based on the first QoS flow being different from the second QoS flow.

In some examples, to support obtaining the indication of the PDU set dependency pattern, the PDU set dependency pattern component 925 may be configured as or otherwise support a means for obtaining the first PDU set and metadata associated with the first PDU set, the metadata indicating the PDU set dependency pattern, where the second PDU set is dependent on the first PDU set based on the PDU set dependency pattern.

In some examples, the PDU sequence number component 945 may be configured as or otherwise support a means for obtaining, as part of the metadata, an indication of a PDU sequence number associated with the second PDU set. In some examples, the indication of the PDU sequence number includes an absolute value, a relative value with respect to a PDU sequence number associated with the first PDU set, or a bitmap.

In some examples, the first QoS flow is different from the second QoS flow, and the QoS component 950 may be configured as or otherwise support a means for obtaining, as part of the metadata, an indication of a QFI for the second QoS flow. In some examples, the indication of the QFI includes an absolute value, a relative value with respect to a QFI associated with the first PDU set, or a bitmap. In some examples, the indication of the QFI for the second QoS flow corresponds to a PDU sequence number associated with the second PDU set.

In some examples, the PDU set dependency pattern component 925 may be configured as or otherwise support a means for obtaining, as part of the metadata, an indication of a highest dependency depth for the first PDU set, the highest dependency depth corresponding to a recurrent dependency level associated with a subset of PDU sets of the group of PDU sets that depend on the first PDU set for the decoding.

In some examples, the PDU set dependency pattern component 925 may be configured as or otherwise support a means for obtaining, as part of the metadata, an indication of an actual dependency depth for the first PDU set, the actual dependency depth associated with a quantity of PDU sets that depend on the first PDU set.

In some examples, the PDU set dependency pattern component 925 may be configured as or otherwise support a means for obtaining a message indicating a threshold actual dependency depth for the group of PDU sets.

In some examples, to support obtaining the indication of the PDU set dependency pattern, the PDU set component 930 may be configured as or otherwise support a means for obtaining the first PDU set and metadata associated with the first PDU set. In some examples, to support obtaining the indication of the PDU set dependency pattern, the PDU set dependency pattern component 925 may be configured as or otherwise support a means for obtaining second metadata associated with the second PDU set, the second metadata indicating the PDU set dependency pattern, where the second PDU set is dependent on the first PDU set based on the PDU set dependency pattern.

In some examples, the PDU set dependency pattern component 925 may be configured as or otherwise support a means for obtaining, as part of the metadata, an indication of a highest dependency depth for the second PDU set, the highest dependency depth corresponding to a recurrent dependency level associated with a subset of PDU sets of the group of PDU sets on which the second PDU set depends for the decoding.

In some examples, the PDU set dependency pattern component 925 may be configured as or otherwise support a means for obtaining, as part of the metadata, an indication of an actual dependency depth for the second PDU set, the actual dependency depth associated with a quantity of PDU sets on which the second PDU set depends.

In some examples, to support obtaining the indication of the PDU set dependency pattern, the PDU set dependency pattern component 925 may be configured as or otherwise support a means for obtaining, by a modem of the wireless device, the indication of the PDU set dependency pattern from an application function of the wireless device. In some examples, to support obtaining the indication of the PDU set dependency pattern, the PDU set dependency pattern component 925 may be configured as or otherwise support a means for obtaining, from a UE, the indication of the PDU set dependency pattern via an RRC message or a MAC-CE.

Additionally, or alternatively, the communications manager 920 may support wireless communications at a wireless device in accordance with examples as disclosed herein. The encoding component 940 may be configured as or otherwise support a means for encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. In some examples, the PDU set dependency pattern component 925 may be configured as or otherwise support a means for outputting an indication of the PDU set dependency pattern based on the encoding. In some examples, the PDU set component 930 may be configured as or otherwise support a means for outputting the second PDU set, where the first PDU set is associated with a first QoS flow and the second PDU set is associated with a second QoS flow.

In some examples, to support outputting the indication of the PDU set dependency pattern, the PDU set dependency pattern component 925 may be configured as or otherwise support a means for outputting, via a control plane, a message including the PDU set dependency pattern.

In some examples, the PDU set dependency pattern component 925 may be configured as or otherwise support a means for outputting, as part of metadata associated with the first PDU set, an indication of a start of the PDU dependency pattern.

In some examples, to support outputting the indication of the PDU set dependency pattern, the PDU set dependency pattern component 925 may be configured as or otherwise support a means for outputting the first PDU set and metadata associated with the first PDU set, the metadata indicating the PDU set dependency pattern.

In some examples, to support outputting the indication of the PDU set dependency pattern, the PDU set component 930 may be configured as or otherwise support a means for outputting the first PDU set and first metadata associated with the first PDU set. In some examples, to support outputting the indication of the PDU set dependency pattern, the PDU set dependency pattern component 925 may be configured as or otherwise support a means for outputting second metadata associated with the second PDU set, the first metadata and the second metadata indicating the PDU set dependency pattern.

In some examples, a value of a first bit in the first metadata indicates whether the first PDU set is dependent on the second PDU set for the encoding based on a frame type associated with the first PDU set and the second PDU set. In some examples, a value of a second bit in the second metadata indicates whether the second PDU set is dependent on the first PDU set for the encoding based on a frame type associated with the first PDU set and the second PDU set.

In some examples, the first metadata further indicates a QFI for the first QoS flow and the second metadata further indicates a QFI for the second QoS flow, the first QoS flow being different from the second QoS flow.

In some examples, the first metadata further indicates a frame type associated with the first PDU set and the second metadata further indicates a frame type associated with the second PDU set. In some examples, the second PDU set is dependent on the one or more PDU sets of the group of PDU sets for the encoding.

In some examples, the second metadata further indicates one or more QFIs associated with the one or more PDU sets of the group of PDU sets based on the first QoS flow being different from the second QoS flow.

In some examples, the first metadata indicates one or more PDU set sequency numbers associated with one or more PDU sets of the group of PDU sets. In some examples, the one or more PDU sets of the group of PDU sets are dependent on the first PDU set for the encoding. In some examples, the first metadata further indicates one or more QFIs associated with the one or more PDU sets of the group of PDU sets based on the first QoS flow being different from the second QoS flow.

In some examples, to support outputting the indication of the PDU set dependency pattern, the PDU set dependency pattern component 925 may be configured as or otherwise support a means for outputting the first PDU set and metadata associated with the first PDU set, the metadata indicating the PDU set dependency pattern, where the second PDU set is dependent on the first PDU set based on the PDU set dependency pattern.

In some examples, the PDU sequence number component 945 may be configured as or otherwise support a means for outputting, as part of the metadata, an indication of a PDU sequence number associated with the second PDU set. In some examples, the indication of the PDU sequence number includes an absolute value, a relative value with respect to a PDU sequence number associated with the first PDU set, or a bitmap.

In some examples, the first QoS flow is different from the second QoS flow, and the QoS component 950 may be configured as or otherwise support a means for outputting, as part of the metadata, an indication of a QFI for the second QoS flow. In some examples, the indication of the QFI includes an absolute value, a relative value with respect to a QFI associated with the first PDU set, or a bitmap. In some examples, the indication of the QFI for the second QoS flow corresponds to a PDU sequence number associated with the second PDU set.

In some examples, the PDU set dependency pattern component 925 may be configured as or otherwise support a means for outputting, as part of the metadata, an indication of a highest dependency depth for the first PDU set, the highest dependency depth corresponding to a recurrent dependency level associated with a subset of PDU sets of the group of PDU sets that depend on the first PDU set for the encoding.

In some examples, the PDU set dependency pattern component 925 may be configured as or otherwise support a means for outputting, as part of the metadata, an indication of an actual dependency depth for the first PDU set, the actual dependency depth associated with a quantity of PDU sets that depend on the first PDU set.

In some examples, the PDU set dependency pattern component 925 may be configured as or otherwise support a means for obtaining a message indicating a threshold actual dependency depth for the group of PDU sets.

In some examples, to support outputting the indication of the PDU set dependency pattern, the PDU set component 930 may be configured as or otherwise support a means for outputting the first PDU set and metadata associated with the first PDU set. In some examples, to support outputting the indication of the PDU set dependency pattern, the PDU set dependency pattern component 925 may be configured as or otherwise support a means for outputting second metadata associated with the second PDU set, the second metadata indicating the PDU set dependency pattern, where the second PDU set is dependent on the first PDU set based on the PDU set dependency pattern.

In some examples, the PDU set dependency pattern component 925 may be configured as or otherwise support a means for outputting, as part of the metadata, an indication of a highest dependency depth for the second PDU set, the highest dependency depth corresponding to a recurrent dependency level associated with a subset of PDU sets of the group of PDU sets on which the second PDU set depends for the encoding.

In some examples, the PDU set dependency pattern component 925 may be configured as or otherwise support a means for outputting, as part of the metadata, an indication of an actual dependency depth for the second PDU set, the actual dependency depth associated with a quantity of PDU sets on which the second PDU set depends.

In some examples, to support outputting the indication of the PDU set dependency pattern, the PDU set dependency pattern component 925 may be configured as or otherwise support a means for outputting the indication of the PDU set dependency pattern by an application function of the wireless device.

In some examples, to support outputting the indication of the PDU set dependency pattern, the PDU set dependency pattern component 925 may be configured as or otherwise support a means for outputting the indication of the PDU set dependency pattern via an RRC message or a MAC-CE.

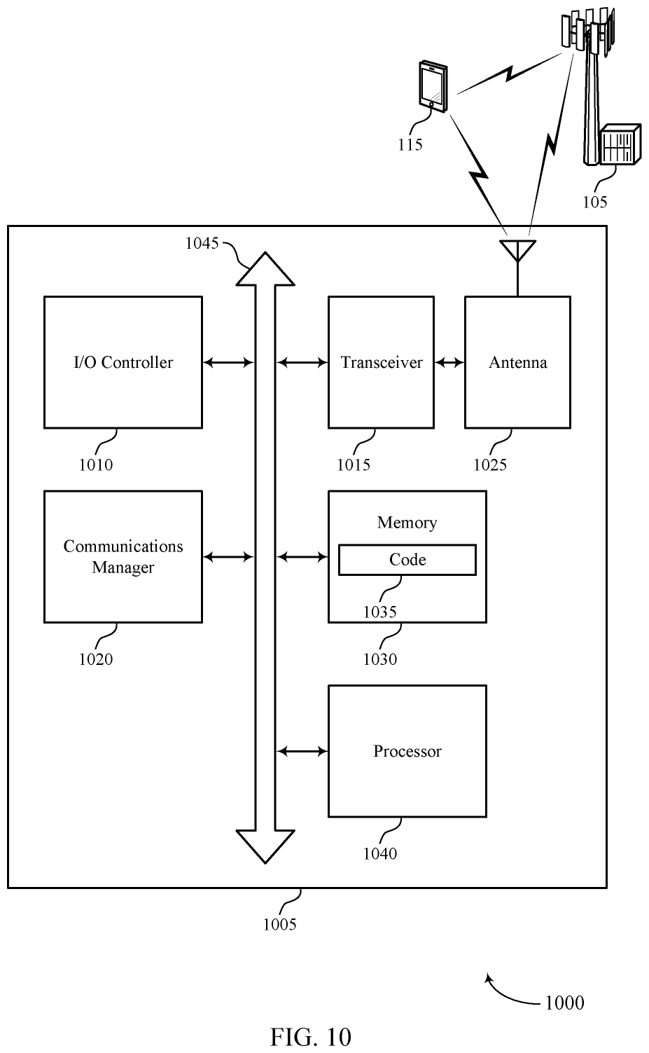

FIG. 10 illustrates a diagram of a system 1000 including a device 1005 that supports dependency in PDU set metadata in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting dependency in PDU set metadata). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a wireless device in accordance with examples as disclosed herein. For example, the communications manager 1020 may be configured as or otherwise support a means for obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The communications manager 1020 may be configured as or otherwise support a means for obtaining the second PDU set, where the first PDU set is associated with a first QoS flow and the second PDU set is associated with a second QoS flow. The communications manager 1020 may be configured as or otherwise support a means for decoding at least the first PDU set and the second PDU set based on the PDU set dependency pattern.

Additionally, or alternatively, the communications manager 1020 may support wireless communications at a wireless device in accordance with examples as disclosed herein. For example, the communications manager 1020 may be configured as or otherwise support a means for encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The communications manager 1020 may be configured as or otherwise support a means for outputting an indication of the PDU set dependency pattern based on the encoding. The communications manager 1020 may be configured as or otherwise support a means for outputting the second PDU set, where the first PDU set is associated with a first QoS flow and the second PDU set is associated with a second QoS flow.

By including or configuring the communications manager 1020 in accordance with examples as described herein, the device 1005 may support techniques for improved handling and processing of PDU sets. For example, the device 1005 may process PDU sets based on a corresponding PDU set dependency pattern. The device 1005 may discard PDU sets that depend on a PDU set that was not successfully received or decoded, which may reduce processing and power consumption. Additionally, the device 1005 may handle PDU sets based on a relative importance or priority as indicated by the PDU set dependency pattern, which may provide more efficient utilization of communication resources and improve communications reliability. For example, the device 1005 may schedule a PDU set on which other PDU sets depend with a relatively robust MCS, which may improve the likelihood that the PDU set is successfully received and decoded.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of dependency in PDU set metadata as described herein, or the processor 1040 and the memory 1030 may be otherwise configured to perform or support such operations.

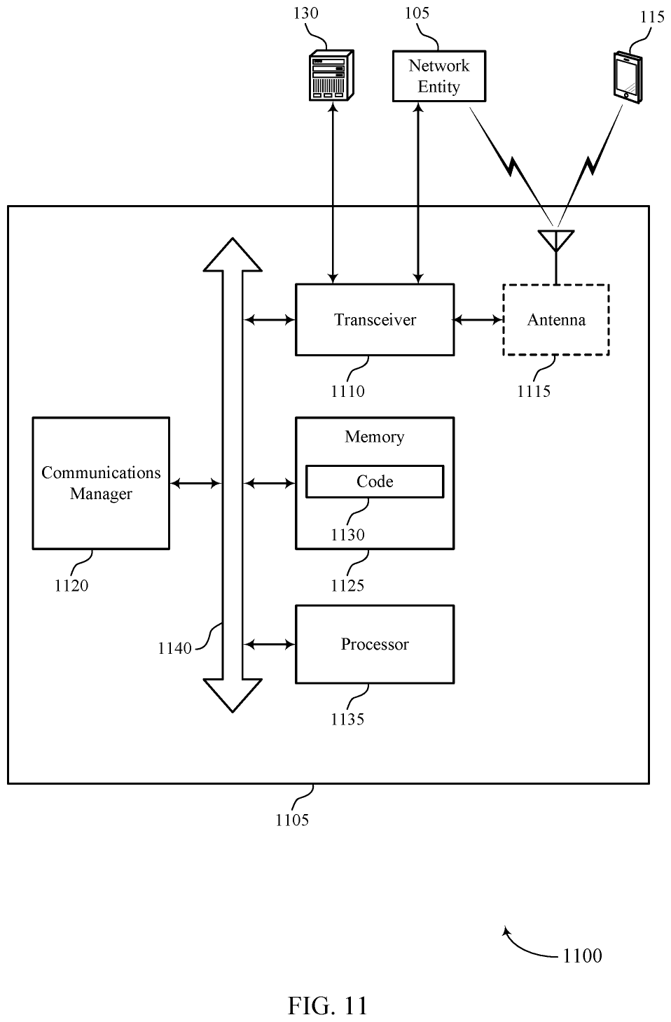

FIG. 11 illustrates a diagram of a system 1100 including a device 1105 that supports dependency in PDU set metadata in accordance with one or more aspects of the present disclosure. The device 1105 may be an example of or include the components of a device 705, a device 805, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting dependency in PDU set metadata). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a wireless device in accordance with examples as disclosed herein. For example, the communications manager 1120 may be configured as or otherwise support a means for obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The communications manager 1120 may be configured as or otherwise support a means for obtaining the second PDU set, where the first PDU set is associated with a first QoS flow and the second PDU set is associated with a second QoS flow. The communications manager 1120 may be configured as or otherwise support a means for decoding at least the first PDU set and the second PDU set based on the PDU set dependency pattern.

Additionally, or alternatively, the communications manager 1120 may support wireless communications at a wireless device in accordance with examples as disclosed herein. For example, the communications manager 1120 may be configured as or otherwise support a means for encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The communications manager 1120 may be configured as or otherwise support a means for outputting an indication of the PDU set dependency pattern based on the encoding. The communications manager 1120 may be configured as or otherwise support a means for outputting the second PDU set, where the first PDU set is associated with a first QoS flow and the second PDU set is associated with a second QoS flow.

By including or configuring the communications manager 1120 in accordance with examples as described herein, the device 1105 may support techniques for improved processing and handling of PDU sets. For example, the device 1105 may process PDU sets based on a corresponding PDU set dependency pattern. The device 1105 may discard PDU sets that depend on a PDU set that was not successfully received or decoded, which may reduce processing and power consumption. Additionally, the device 1105 may handle PDU sets based on a relative importance or priority as indicated by the PDU set dependency pattern, which may provide more efficient utilization of communication resources and improve communications reliability. For example, the device 1105 may schedule a PDU set on which other PDU sets depend with a relatively robust MCS, which may improve the likelihood that the PDU set is successfully received and decoded.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of dependency in PDU set metadata as described herein, or the processor 1135 and the memory 1125 may be otherwise configured to perform or support such operations.

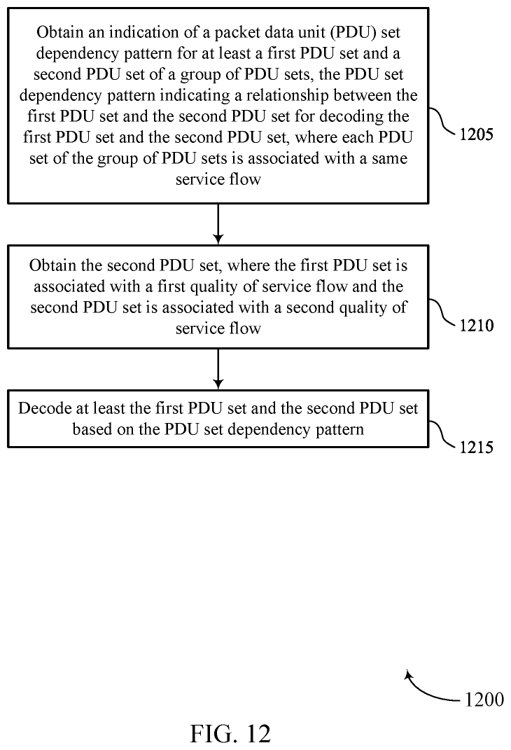

FIG. 12 illustrates a flowchart illustrating a method 1200 that supports dependency in PDU set metadata in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow. The operations of 1205 may be performed in accordance with examples as disclosed herein. In some examples, aspects of the operations of 1205 may be performed by a PDU set dependency pattern component 925 as described with reference to FIG. 9.

At 1210, the method may include obtaining the second PDU set, where the first PDU set is associated with a first QoS flow and the second PDU set is associated with a second QoS flow. The operations of 1210 may be performed in accordance with examples as disclosed herein. In some examples, aspects of the operations of 1210 may be performed by a PDU set component 930 as described with reference to FIG. 9.

At 1215, the method may include decoding at least the first PDU set and the second PDU set based on the PDU set dependency pattern. The operations of 1215 may be performed in accordance with examples as disclosed herein. In some examples, aspects of the operations of 1215 may be performed by a decoding component 935 as described with reference to FIG. 9.

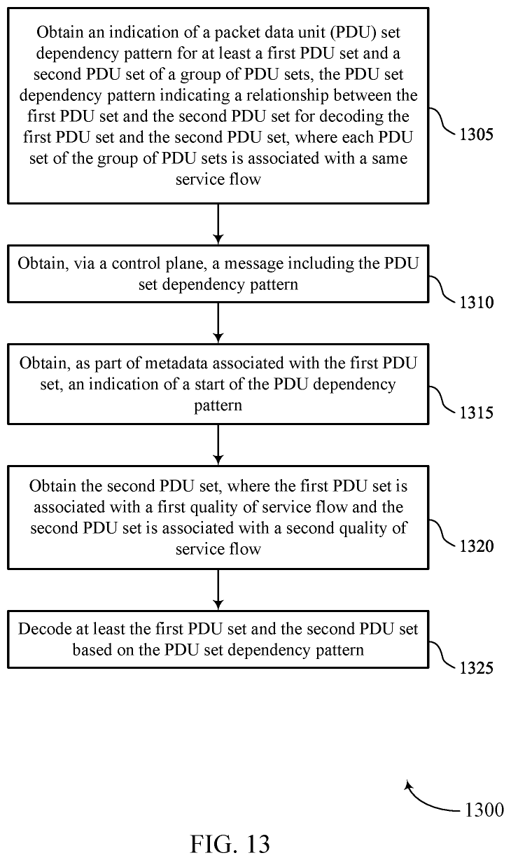

FIG. 13 illustrates a flowchart illustrating a method 1300 that supports dependency in PDU set metadata in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets is associated with a same service flow. The operations of 1305 may be performed in accordance with examples as disclosed herein. In some examples, aspects of the operations of 1305 may be performed by a PDU set dependency pattern component 925 as described with reference to FIG. 9.

At 1310, the method may include obtaining, via a control plane, a message including the PDU set dependency pattern. The operations of 1310 may be performed in accordance with examples as disclosed herein. In some examples, aspects of the operations of 1310 may be performed by a PDU set dependency pattern component 925 as described with reference to FIG. 9.

At 1315, the method may include obtaining, as part of metadata associated with the first PDU set, an indication of a start of the PDU dependency pattern. The operations of 1315 may be performed in accordance with examples as disclosed herein. In some examples, aspects of the operations of 1315 may be performed by a PDU set dependency pattern component 925 as described with reference to FIG. 9.

At 1320, the method may include obtaining the second PDU set, where the first PDU set is associated with a first QoS flow and the second PDU set is associated with a second QoS flow. The operations of 1320 may be performed in accordance with examples as disclosed herein. In some examples, aspects of the operations of 1320 may be performed by a PDU set component 930 as described with reference to FIG. 9.

At 1325, the method may include decoding at least the first PDU set and the second PDU set based on the PDU set dependency pattern. The operations of 1325 may be performed in accordance with examples as disclosed herein. In some examples, aspects of the operations of 1325 may be performed by a decoding component 935 as described with reference to FIG. 9.

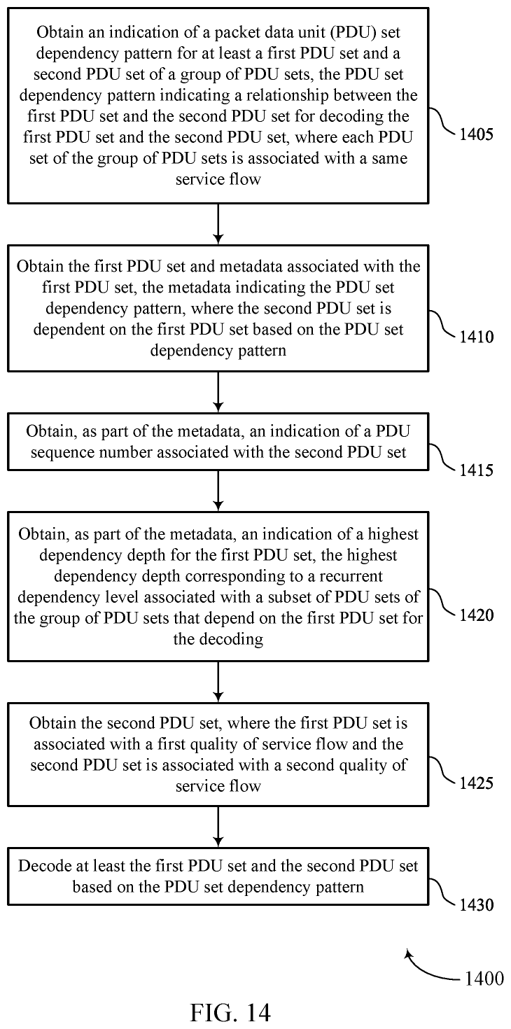

FIG. 14 illustrates a flowchart illustrating a method 1400 that supports dependency in PDU set metadata in accordance with one or more aspects of the present disclosure. The operations of the method 1400 may be implemented by a UE or a network entity or its components as described herein. For example, the operations of the method 1400 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include obtaining an indication of a PDU set dependency pattern for at least a first PDU set and a second PDU set of a group of PDU sets, the PDU set dependency pattern indicating a relationship between the first PDU set and the second PDU set for decoding the first PDU set and the second PDU set, where each PDU set of the group of PDU sets are associated with a same service flow. The operations of 1405 may be performed in accordance with examples as disclosed herein. In some examples, aspects of the operations of 1405 may be performed by a PDU set dependency pattern component 925 as described with reference to FIG. 9.

At 1410, the method may include obtaining the first PDU set and metadata associated with the first PDU set, the metadata indicating the PDU set dependency pattern, where the second PDU set is dependent on the first PDU set based on the PDU set dependency pattern. The operations of 1410 may be performed in accordance with examples as disclosed herein. In some examples, aspects of the operations of 1410 may be performed by a PDU set dependency pattern component 925 as described with reference to FIG. 9.

At 1415, the method may include obtaining, as part of the metadata, an indication of a PDU sequence number associated with the second PDU set. The operations of 1415 may be performed in accordance with examples as disclosed herein. In some examples, aspects of the operations of 1415 may be performed by a PDU sequence number component 945 as described with reference to FIG. 9.

At 1420, the method may include obtaining, as part of the metadata, an indication of a highest dependency depth for the first PDU set, the highest dependency depth corresponding to a recurrent dependency level associated with a subset of PDU sets of the group of PDU sets that depend on the first PDU set for the decoding. The operations of 1420 may be performed in accordance with examples as disclosed herein. In some examples, aspects of the operations of 1420 may be performed by a PDU set dependency pattern component 925 as described with reference to FIG. 9.

At 1425, the method may include obtaining the second PDU set, where the first PDU set is associated with a first QoS flow and the second PDU set is associated with a second QoS flow. The operations of 1425 may be performed in accordance with examples as disclosed herein. In some examples, aspects of the operations of 1425 may be performed by a PDU set component 930 as described with reference to FIG. 9.

At 1430, the method may include decoding at least the first PDU set and the second PDU set based on the PDU set dependency pattern. The operations of 1430 may be performed in accordance with examples as disclosed herein. In some examples, aspects of the operations of 1430 may be performed by a decoding component 935 as described with reference to FIG. 9.

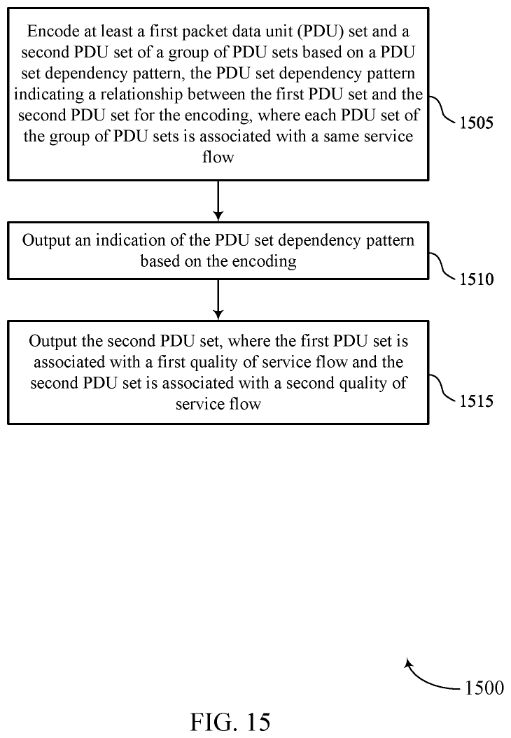

FIG. 15 illustrates a flowchart illustrating a method 1500 that supports dependency in PDU set metadata in accordance with one or more aspects of the present disclosure. The operations of the method 1500 may be implemented by a UE or a network entity or its components as described herein. For example, the operations of the method 1500 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The operations of 1505 may be performed in accordance with examples as disclosed herein. In some examples, aspects of the operations of 1505 may be performed by an encoding component 940 as described with reference to FIG. 9.

At 1510, the method may include outputting an indication of the PDU set dependency pattern based on the encoding. The operations of 1510 may be performed in accordance with examples as disclosed herein. In some examples, aspects of the operations of 1510 may be performed by a PDU set dependency pattern component 925 as described with reference to FIG. 9.

At 1515, the method may include outputting the second PDU set, where the first PDU set is associated with a first QoS flow and the second PDU set is associated with a second QoS flow. The operations of 1515 may be performed in accordance with examples as disclosed herein. In some examples, aspects of the operations of 1515 may be performed by a PDU set component 930 as described with reference to FIG. 9.

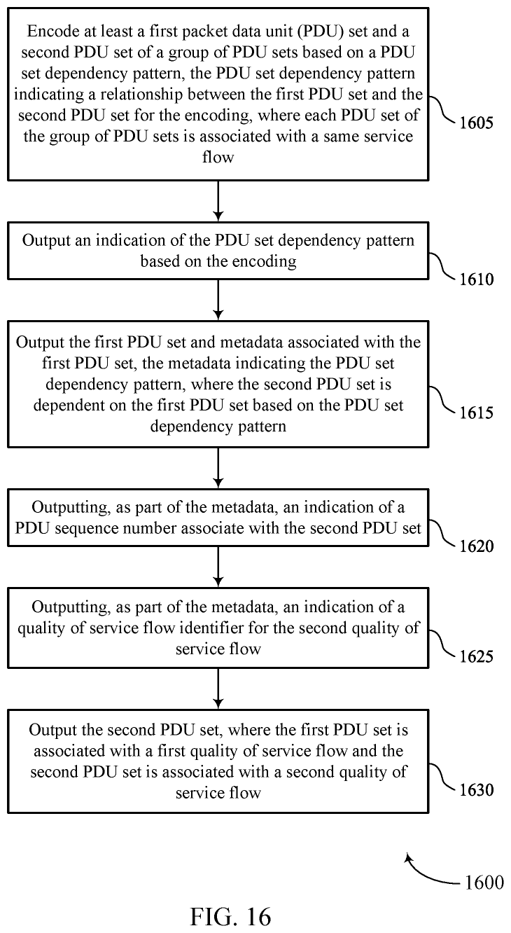

FIG. 16 illustrates a flowchart illustrating a method 1600 that supports dependency in PDU set metadata in accordance with one or more aspects of the present disclosure. The operations of the method 1600 may be implemented by a UE or a network entity or its components as described herein. For example, the operations of the method 1600 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include encoding at least a first PDU set and a second PDU set of a group of PDU sets based on a PDU set dependency pattern, the PDU set dependency pattern indicating a relationship between the first PDU set and the second PDU set for the encoding, where each PDU set of the group of PDU sets are associated with a same service flow. The operations of 1605 may be performed in accordance with examples as disclosed herein. In some examples, aspects of the operations of 1605 may be performed by an encoding component 940 as described with reference to FIG. 9.

At 1610, the method may include outputting an indication of the PDU set dependency pattern based on the encoding. The operations of 1610 may be performed in accordance with examples as disclosed herein. In some examples, aspects of the operations of 1610 may be performed by a PDU set dependency pattern component 925 as described with reference to FIG. 9.

At 1615, the method may include outputting the first PDU set and metadata associated with the first PDU set, the metadata indicating the PDU set dependency pattern, where the second PDU set is dependent on the first PDU set based on the PDU set dependency pattern. The operations of 1615 may be performed in accordance with examples as disclosed herein. In some examples, aspects of the operations of 1615 may be performed by a PDU set dependency pattern component 925 as described with reference to FIG. 9.

At 1620, the method may include outputting, as part of the metadata, an indication of a PDU sequence number associated with the second PDU set. The operations of 1620 may be performed in accordance with examples as disclosed herein. In some examples, aspects of the operations of 1620 may be performed by a PDU sequence number component 945 as described with reference to FIG. 9.

At 1625, the method may include outputting, as part of the metadata, an indication of a QFI for the second QoS flow. The operations of 1625 may be performed in accordance with examples as disclosed herein. In some examples, aspects of the operations of 1625 may be performed by a QoS component 950 as described with reference to FIG. 9.

At 1630, the method may include outputting the second PDU set, where the first PDU set is associated with a first QoS flow and the second PDU set is associated with a second QoS flow. The operations of 1630 may be performed in accordance with examples as disclosed herein. In some examples, aspects of the operations of 1630 may be performed by a PDU set component 930 as described with reference to FIG. 9.

The following provides an overview of aspects of the present disclosure:

Aspect 1: A method for wireless communications at a wireless device, comprising: obtaining an indication of a packet data unit (PDU) set dependency pattern for at least a first PDU set and a second PDU set of a group of PDU sets, the PDU set dependency pattern indicating a relationship between the first PDU set and the second PDU set for decoding the first PDU set and the second PDU set, wherein each PDU set of the group of PDU sets is associated with a same service flow; obtaining the second PDU set, wherein the first PDU set is associated with a first quality of service flow and the second PDU set is associated with a second quality of service flow; and decoding at least the first PDU set and the second PDU set based at least in part on the PDU set dependency pattern.

Aspect 2: The method of aspect 1, wherein obtaining the indication of the PDU set dependency pattern comprises: obtaining, via a control plane, a message comprising the PDU set dependency pattern.

Aspect 3: The method of aspect 2, further comprising: obtaining, as part of metadata associated with the first PDU set, an indication of a start of the PDU dependency pattern.

Aspect 4: The method of any of aspects 2 through 3, wherein the indication of the PDU set dependency pattern comprises a bitmap associated with the first PDU set having a length equal to a quantity of PDU sets in the group of PDU sets, the bitmap indicating the relationship between the first PDU set and one or more PDU sets of the group of PDU sets.

Aspect 5: The method of aspect 4, wherein each bit of the bitmap corresponds to a respective PDU set of the group of PDU sets, and a value of each bit indicates whether the respective PDU set is dependent on the first PDU set.

Aspect 6: The method of any of aspects 1 through 5, wherein the PDU set dependency pattern is for a subset of PDU sets of the group of PDU sets including the first PDU set and the second PDU set, and wherein obtaining the indication of the PDU set dependency pattern comprises: obtaining the first PDU set and metadata associated with the first PDU set, the metadata indicating the PDU set dependency pattern.

Aspect 7: The method of aspect 6, wherein the PDU set dependency pattern indicates a relationship between each PDU set in the subset of PDU sets.

Aspect 8: The method of any of aspects 6 through 7, wherein the metadata associated with the first PDU set further indicates that the PDU set dependency pattern is to be restarted.

Aspect 9: The method of any of aspects 1 through 8, wherein obtaining the indication of the PDU set dependency pattern comprises: obtaining the first PDU set and first metadata associated with the first PDU set; and obtaining second metadata associated with the second PDU set, the first metadata and the second metadata indicating the PDU set dependency pattern.

Aspect 10: The method of aspect 9, wherein a value of a first bit in the first metadata indicates whether the first PDU set is dependent on the second PDU set for the decoding based at least in part on a frame type associated with the first PDU set and the second PDU set.

Aspect 11: The method of any of aspects 9 through 10, wherein a value of a second bit in the second metadata indicates whether the second PDU set is dependent on the first PDU set for the decoding based at least in part on a frame type associated with the first PDU set and the second PDU set.

Aspect 12: The method of any of aspects 9 through 11, wherein the first metadata further indicates a quality of service flow identifier for the first quality of service flow and the second metadata further indicates a quality of service flow identifier for the second quality of service flow, the first quality of service flow being different from the second quality of service flow.

Aspect 13: The method of any of aspects 9 through 12, wherein the first metadata further indicates a frame type associated with the first PDU set and the second metadata further indicates a frame type associated with the second PDU set.

Aspect 14: The method of any of aspects 9 through 13, wherein the second metadata indicates one or more PDU set sequency numbers associated with one or more PDU sets of the group of PDU sets, and the second PDU set is dependent on the one or more PDU sets of the group of PDU sets for the decoding.

Aspect 15: The method of aspect 14, wherein the second metadata further indicates one or more quality of service flow identifiers associated with the one or more PDU sets of the group of PDU sets based at least in part on the first quality of service flow being different from the second quality of service flow.

Aspect 16: The method of any of aspects 9 through 15, wherein the first metadata indicates one or more PDU set sequency numbers associated with one or more PDU sets of the group of PDU sets, and the one or more PDU sets of the group of PDU sets are dependent on the first PDU set for the decoding.

Aspect 17: The method of aspect 16, wherein the first metadata further indicates one or more quality of service flow identifiers associated with the one or more PDU sets of the group of PDU sets based at least in part on the first quality of service flow being different from the second quality of service flow.

Aspect 18: The method of any of aspects 1 through 17, wherein obtaining the indication of the PDU set dependency pattern comprises: obtaining the first PDU set and metadata associated with the first PDU set, the metadata indicating the PDU set dependency pattern, wherein the second PDU set is dependent on the first PDU set based at least in part on the PDU set dependency pattern.

Aspect 19: The method of aspect 18, further comprising: obtaining, as part of the metadata, an indication of a PDU sequence number associated with the second PDU set.

Aspect 20: The method of aspect 19, wherein the indication of the PDU sequence number comprises an absolute value, a relative value with respect to a PDU sequence number associated with the first PDU set, or a bitmap.

Aspect 21: The method of any of aspects 19 through 20, wherein the first quality of service flow is different from the second quality of service flow, the method further comprising: obtaining, as part of the metadata, an indication of a quality of service flow identifier for the second quality of service flow.

Aspect 22: The method of aspect 21, wherein the indication of the quality of service flow identifier comprises an absolute value, a relative value with respect to a quality of service flow identifier associated with the first PDU set, or a bitmap.

Aspect 23: The method of any of aspects 21 through 22, wherein the indication of the quality of service flow identifier for the second quality of service flow corresponds to a PDU sequence number associated with the second PDU set.

Aspect 24: The method of any of aspects 18 through 23, further comprising: obtaining, as part of the metadata, an indication of a highest dependency depth for the first PDU set, the highest dependency depth corresponding to a recurrent dependency level associated with a subset of PDU sets of the group of PDU sets that depend on the first PDU set for the decoding.

Aspect 25: The method of any of aspects 18 through 24, further comprising: obtaining, as part of the metadata, an indication of an actual dependency depth for the first PDU set, the actual dependency depth associated with a quantity of PDU sets that depend on the first PDU set.

Aspect 26: The method of aspect 25, further comprising: obtaining a message indicating a threshold actual dependency depth for the group of PDU sets.

Aspect 27: The method of any of aspects 1 through 26, wherein obtaining the indication of the PDU set dependency pattern comprises: obtaining the first PDU set and metadata associated with the first PDU set; and obtaining second metadata associated with the second PDU set, the second metadata indicating the PDU set dependency pattern, wherein the second PDU set is dependent on the first PDU set based at least in part on the PDU set dependency pattern.

Aspect 28: The method of aspect 27, further comprising: obtaining, as part of the metadata, an indication of a highest dependency depth for the second PDU set, the highest dependency depth corresponding to a recurrent dependency level associated with a subset of PDU sets of the group of PDU sets on which the second PDU set depends for the decoding.

Aspect 29: The method of any of aspects 27 through 28, further comprising: obtaining, as part of the metadata, an indication of an actual dependency depth for the second PDU set, the actual dependency depth associated with a quantity of PDU sets on which the second PDU set depends.

Aspect 30: The method of any of aspects 1 through 29, wherein obtaining the indication of the PDU set dependency pattern comprises: obtaining, by a modem of the wireless device, the indication of the PDU set dependency pattern from an application function of the wireless device.

Aspect 31: The method of any of aspects 1 through 30, wherein obtaining the indication of the PDU set dependency pattern comprises: obtaining, from a UE, the indication of the PDU set dependency pattern via a radio resource control message or a MAC control element (MAC-CE).

Aspect 32: A method for wireless communications at a wireless device, comprising: encoding at least a first packet data unit (PDU) set and a second PDU set of a group of PDU sets based at least in part on a PDU set dependency pattern, the PDU set dependency pattern indicating a relationship between the first PDU set and the second PDU set for the encoding, wherein each PDU set of the group of PDU sets is associated with a same service flow; outputting an indication of the PDU set dependency pattern based at least in part on the encoding; and outputting the second PDU set, wherein the first PDU set is associated with a first quality of service flow and the second PDU set is associated with a second quality of service flow.

Aspect 33: The method of aspect 32, wherein outputting the indication of the PDU set dependency pattern comprises: outputting, via a control plane, a message comprising the PDU set dependency pattern.

Aspect 34: The method of aspect 33, further comprising: outputting, as part of metadata associated with the first PDU set, an indication of a start of the PDU dependency pattern.

Aspect 35: The method of any of aspects 32 through 34, wherein the PDU set dependency pattern is for a subset of PDU sets of the group of PDU sets including the first PDU set and the second PDU set, and wherein outputting the indication of the PDU set dependency pattern comprises: outputting the first PDU set and metadata associated with the first PDU set, the metadata indicating the PDU set dependency pattern.

Aspect 36: The method of any of aspects 32 through 35, wherein outputting the indication of the PDU set dependency pattern comprises: outputting the first PDU set and first metadata associated with the first PDU set; and outputting second metadata associated with the second PDU set, the first metadata and the second metadata indicating the PDU set dependency pattern.

Aspect 37: The method of aspect 36, wherein a value of a first bit in the first metadata indicates whether the first PDU set is dependent on the second PDU set for the encoding based at least in part on a frame type associated with the first PDU set and the second PDU set.

Aspect 38: The method of any of aspects 36 through 37, wherein a value of a second bit in the second metadata indicates whether the second PDU set is dependent on the first PDU set for the encoding based at least in part on a frame type associated with the first PDU set and the second PDU set.

Aspect 39: The method of any of aspects 36 through 38, wherein the first metadata further indicates a quality of service flow identifier for the first quality of service flow and the second metadata further indicates a quality of service flow identifier for the second quality of service flow, the first quality of service flow being different from the second quality of service flow.

Aspect 40: The method of any of aspects 36 through 39, wherein the first metadata further indicates a frame type associated with the first PDU set and the second metadata further indicates a frame type associated with the second PDU set.

Aspect 41: The method of any of aspects 36 through 40, wherein the second metadata indicates one or more PDU set sequence numbers associated with one or more PDU sets of the group of PDU sets, and the second PDU set is dependent on the one or more PDU sets of the group of PDU sets for the encoding.

Aspect 42: The method of aspect 41, wherein the second metadata further indicates one or more quality of service flow identifiers associated with the one or more PDU sets of the group of PDU sets based at least in part on the first quality of service flow being different from the second quality of service flow.

Aspect 43: The method of any of aspects 36 through 42, wherein the first metadata indicates one or more PDU set sequency numbers associated with one or more PDU sets of the group of PDU sets, and the one or more PDU sets of the group of PDU sets are dependent on the first PDU set for the encoding.

Aspect 44: The method of aspect 43, wherein the first metadata further indicates one or more quality of service flow identifiers associated with the one or more PDU sets of the group of PDU sets based at least in part on the first quality of service flow being different from the second quality of service flow.

Aspect 45: The method of any of aspects 32 through 44, wherein outputting the indication of the PDU set dependency pattern comprises: outputting the first PDU set and metadata associated with the first PDU set, the metadata indicating the PDU set dependency pattern, wherein the second PDU set is dependent on the first PDU set based at least in part on the PDU set dependency pattern.

Aspect 46: The method of aspect 45, further comprising: outputting, as part of the metadata, an indication of a PDU sequence number associated with the second PDU set.

Aspect 47: The method of aspect 46, wherein the indication of the PDU sequence number comprises an absolute value, a relative value with respect to a PDU sequence number associated with the first PDU set, or a bitmap.

Aspect 48: The method of any of aspects 46 through 47, wherein the first quality of service flow is different from the second quality of service flow, the method further comprising: outputting, as part of the metadata, an indication of a quality of service flow identifier for the second quality of service flow.

Aspect 49: The method of aspect 48, wherein the indication of the quality of service flow identifier comprises an absolute value, a relative value with respect to a quality of service flow identifier associated with the first PDU set, or a bitmap.

Aspect 50: The method of any of aspects 48 through 49, wherein the indication of the quality of service flow identifier for the second quality of service flow corresponds to a PDU sequence number associated with the second PDU set.

Aspect 51: The method of any of aspects 45 through 50, further comprising: outputting, as part of the metadata, an indication of a highest dependency depth for the first PDU set, the highest dependency depth corresponding to a recurrent dependency level associated with a subset of PDU sets of the group of PDU sets that depend on the first PDU set for the encoding.

Aspect 52: The method of any of aspects 45 through 51, further comprising: outputting, as part of the metadata, an indication of an actual dependency depth for the first PDU set, the actual dependency depth associated with a quantity of PDU sets that depend on the first PDU set.

Aspect 53: The method of aspect 52, further comprising: obtaining a message indicating a threshold actual dependency depth for the group of PDU sets.

Aspect 54: The method of any of aspects 32 through 53, wherein outputting the indication of the PDU set dependency pattern comprises: outputting the first PDU set and metadata associated with the first PDU set; and outputting second metadata associated with the second PDU set, the second metadata indicating the PDU set dependency pattern, wherein the second PDU set is dependent on the first PDU set based at least in part on the PDU set dependency pattern.

Aspect 55: The method of aspect 54, further comprising: outputting, as part of the metadata, an indication of a highest dependency depth for the second PDU set, the highest dependency depth corresponding to a recurrent dependency level associated with a subset of PDU sets of the group of PDU sets on which the second PDU set depends for the encoding.

Aspect 56: The method of any of aspects 54 through 55, further comprising: outputting, as part of the metadata, an indication of an actual dependency depth for the second PDU set, the actual dependency depth associated with a quantity of PDU sets on which the second PDU set depends.

Aspect 57: The method of any of aspects 32 through 56, wherein outputting the indication of the PDU set dependency pattern comprises: outputting the indication of the PDU set dependency pattern by an application function of the wireless device.

Aspect 58: The method of any of aspects 32 through 57, wherein outputting the indication of the PDU set dependency pattern comprises: outputting the indication of the PDU set dependency pattern via a radio resource control message or a MAC control element (MAC-CE).

Aspect 59: An apparatus for wireless communications at a wireless device, comprising a processor; memory coupled with the processor; and instructions stored in the memory and executable by the processor to cause the apparatus to perform a method of any of aspects 1 through 31.

Aspect 60: An apparatus for wireless communications at a wireless device, comprising at least one means for performing a method of any of aspects 1 through 31.

Aspect 61: A non-transitory computer-readable medium storing code for wireless communications at a wireless device, the code comprising instructions executable by a processor to perform a method of any of aspects 1 through 31.

Aspect 62: An apparatus for wireless communications at a wireless device, comprising a processor; memory coupled with the processor; and instructions stored in the memory and executable by the processor to cause the apparatus to perform a method of any of aspects 32 through 58.

Aspect 63: An apparatus for wireless communications at a wireless device, comprising at least one means for performing a method of any of aspects 32 through 58.

Aspect 64: A non-transitory computer-readable medium storing code for wireless communications at a wireless device, the code comprising instructions executable by a processor to perform a method of any of aspects 32 through 58.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a wireless device, comprising:
obtaining an indication of a packet data unit (PDU) set dependency pattern for at least a first PDU set and a second PDU set of a group of PDU sets, the PDU set dependency pattern indicating a relationship between the first PDU set and the second PDU set for decoding the first PDU set and the second PDU set, wherein each PDU set of the group of PDU sets is associated with a same service flow;
obtaining the second PDU set, wherein the first PDU set is associated with a first quality of service flow and the second PDU set is associated with a second quality of service flow; and
decoding at least the first PDU set and the second PDU set based at least in part on the PDU set dependency pattern.

2. The method of claim 1, wherein obtaining the indication of the PDU set dependency pattern comprises:
obtaining, via a control plane, a message comprising the PDU set dependency pattern.

3. The method of claim 2, further comprising:
obtaining, as part of metadata associated with the first PDU set, an indication of a start of the PDU dependency pattern.

4. The method of claim 2, wherein the indication of the PDU set dependency pattern comprises a bitmap associated with the first PDU set having a length equal to a quantity of PDU sets in the group of PDU sets, the bitmap indicating the relationship between the first PDU set and one or more PDU sets of the group of PDU sets.

5. The method of claim 4, wherein:
each bit of the bitmap corresponds to a respective PDU set of the group of PDU sets, and
a value of each bit indicates whether the respective PDU set is dependent on the first PDU set.

6. The method of claim 1, wherein the PDU set dependency pattern is for a subset of PDU sets of the group of PDU sets including the first PDU set and the second PDU set, and wherein obtaining the indication of the PDU set dependency pattern comprises:
obtaining the first PDU set and metadata associated with the first PDU set, the metadata indicating the PDU set dependency pattern.

7. The method of claim 6, wherein the PDU set dependency pattern indicates a relationship between each PDU set in the subset of PDU sets.

8. The method of claim 6, wherein the metadata associated with the first PDU set further indicates that the PDU set dependency pattern is to be restarted.

9. The method of claim 1, wherein obtaining the indication of the PDU set dependency pattern comprises:
obtaining the first PDU set and first metadata associated with the first PDU set; and
obtaining second metadata associated with the second PDU set, the first metadata and the second metadata indicating the PDU set dependency pattern.

10. The method of claim 9, wherein a value of a first bit in the first metadata indicates whether the first PDU set is dependent on the second PDU set for the decoding based at least in part on a frame type associated with the first PDU set and the second PDU set.

11. The method of claim 9, wherein a value of a second bit in the second metadata indicates whether the second PDU set is dependent on the first PDU set for the decoding based at least in part on a frame type associated with the first PDU set and the second PDU set.

12. The method of claim 9, wherein the first metadata further indicates a quality of service flow identifier for the first quality of service flow and the second metadata further indicates a quality of service flow identifier for the second quality of service flow, the first quality of service flow being different from the second quality of service flow.

13. The method of claim 9, wherein the first metadata further indicates a frame type associated with the first PDU set and the second metadata further indicates a frame type associated with the second PDU set.

14. The method of claim 9, wherein:
the second metadata indicates one or more PDU set sequency numbers associated with one or more PDU sets of the group of PDU sets, and
the second PDU set is dependent on the one or more PDU sets of the group of PDU sets for the decoding.

15. The method of claim 14, wherein the second metadata further indicates one or more quality of service flow identifiers associated with the one or more PDU sets of the group of PDU sets based at least in part on the first quality of service flow being different from the second quality of service flow.

16. The method of claim 9, wherein:
the first metadata indicates one or more PDU set sequency numbers associated with one or more PDU sets of the group of PDU sets, and
the one or more PDU sets of the group of PDU sets are dependent on the first PDU set for the decoding.

17. The method of claim 16, wherein the first metadata further indicates one or more quality of service flow identifiers associated with the one or more PDU sets of the group of PDU sets based at least in part on the first quality of service flow being different from the second quality of service flow.

18. The method of claim 1, wherein obtaining the indication of the PDU set dependency pattern comprises:
obtaining the first PDU set and metadata associated with the first PDU set, the metadata indicating the PDU set dependency pattern, wherein the second PDU set is dependent on the first PDU set based at least in part on the PDU set dependency pattern.

19. The method of claim 18, further comprising:
obtaining, as part of the metadata, an indication of a PDU sequence number associated with the second PDU set, wherein the indication of the PDU sequence number comprises an absolute value, a relative value with respect to a PDU sequence number associated with the first PDU set, or a bitmap.

20. The method of claim 18, wherein the first quality of service flow is different from the second quality of service flow, the method further comprising:
obtaining, as part of the metadata, an indication of a quality of service flow identifier for the second quality of service flow, wherein the indication of the quality of service flow identifier comprises an absolute value, a relative value with respect to a quality of service flow identifier associated with the first PDU set, or a bitmap.

21. The method of claim 20, wherein the indication of the quality of service flow identifier for the second quality of service flow corresponds to a PDU sequence number associated with the second PDU set.

22. The method of claim 18, further comprising:
obtaining, as part of the metadata, an indication of a highest dependency depth for the first PDU set, the highest dependency depth corresponding to a recurrent dependency level associated with a subset of PDU sets of the group of PDU sets that depend on the first PDU set for the decoding.

23. The method of claim 18, further comprising:
obtaining, as part of the metadata, an indication of an actual dependency depth for the first PDU set, the actual dependency depth associated with a quantity of PDU sets that depend on the first PDU set.

24. The method of claim 23, further comprising:
obtaining a message indicating a threshold actual dependency depth for the group of PDU sets.

25. The method of claim 1, wherein obtaining the indication of the PDU set dependency pattern comprises:
obtaining the first PDU set and metadata associated with the first PDU set; and
obtaining second metadata associated with the second PDU set, the second metadata indicating the PDU set dependency pattern, wherein the second PDU set is dependent on the first PDU set based at least in part on the PDU set dependency pattern.

26. The method of claim 25, further comprising:
obtaining, as part of the metadata, an indication of a highest dependency depth for the second PDU set, the highest dependency depth corresponding to a recurrent dependency level associated with a subset of PDU sets of the group of PDU sets on which the second PDU set depends for the decoding.

27. The method of claim 25, further comprising:
obtaining, as part of the metadata, an indication of an actual dependency depth for the second PDU set, the actual dependency depth associated with a quantity of PDU sets on which the second PDU set depends.

28. A method for wireless communications at a wireless device, comprising:
encoding at least a first packet data unit (PDU) set and a second PDU set of a group of PDU sets based at least in part on a PDU set dependency pattern, the PDU set dependency pattern indicating a relationship between the first PDU set and the second PDU set for the encoding, wherein each PDU set of the group of PDU sets is associated with a same service flow;
outputting an indication of the PDU set dependency pattern based at least in part on the encoding; and
outputting the second PDU set, wherein the first PDU set is associated with a first quality of service flow and the second PDU set is associated with a second quality of service flow.

29. An apparatus for wireless communications at a wireless device, comprising:
a processor;
memory coupled with the processor; and
instructions stored in the memory and executable by the processor to cause the apparatus to:
obtain an indication of a packet data unit (PDU) set dependency pattern for at least a first PDU set and a second PDU set of a group of PDU sets, the PDU set dependency pattern indicating a relationship between the first PDU set and the second PDU set for decoding the first PDU set and the second PDU set, wherein each PDU set of the group of PDU sets is associated with a same service flow;
obtain the second PDU set, wherein the first PDU set is associated with a first quality of service flow and the second PDU set is associated with a second quality of service flow; and
decode at least the first PDU set and the second PDU set based at least in part on the PDU set dependency pattern.

30. An apparatus for wireless communications at a wireless device, comprising:
a processor;
memory coupled with the processor; and
instructions stored in the memory and executable by the processor to cause the apparatus to:
encode at least a first packet data unit (PDU) set and a second PDU set of a group of PDU sets based at least in part on a PDU set dependency pattern, the PDU set dependency pattern indicating a relationship between the first PDU set and the second PDU set for the encoding, wherein each PDU set of the group of PDU sets is associated with a same service flow;
output an indication of the PDU set dependency pattern based at least in part on the encoding; and
output the second PDU set, wherein the first PDU set is associated with a first quality of service flow and the second PDU set is associated with a second quality of service flow.
